(19) United States
(12) Patent Application Publication
(10) Pub. No.: US 2015/0169170 A1
(43) Pub. Date: Jun. 18, 2015

(54) DETECTING A HOVER EVENT USING A SEQUENCE BASED ON CURSOR MOVEMENT

(71) Applicant: Nathan Dickerson BEACH, Sunnyvale, CA (US)

(72) Inventor: Nathan Dickerson BEACH, Sunnyvale, CA (US)

(73) Assignee: GOOGLE INC., Mountain View, CA (US)

(21) Appl. No.: 13/599,070

(22) Filed: Aug. 30, 2012

(51) Int. Cl. G06F 3/0481

(52) U.S. Cl. CPC G06F 3/04812

(57) ABSTRACT

A system is configured to store information regarding a first cursor sequence that resulted in an occurrence of a hover event, and information regarding a second cursor sequence that did not result in an occurrence of the hover event. The system is configured to obtain cursor information that identifies a manner in which a cursor is moved relative to a display of a document; compare the cursor information to the first cursor sequence and the second cursor sequence; determine, based on a result of comparing the cursor information to the first cursor sequence and the second cursor sequence, that the hover event occurred when the cursor information more closely matches the first cursor sequence than the second cursor sequence; and perform an action based on determining that the hover event occurred.

### BACKGROUND

Many techniques are available to users today to find information on the World Wide Web, “web.” For example, users often use web browsers and/or search systems to find information of interest.

Search systems provide search results in response to a search query from a user. The search results typically include links that allow the users to access documents, such as web pages and/or other documents. The search systems may also provide a different corpus of search results, such as images results, video results, product results, etc. A user may use a pointing device, such as a mouse, etc., to move a cursor within a search results document that includes images. The user may hover the cursor over one of the images. Hovering the cursor over the image may cause an information window to be displayed within the search results document. The information window may include a larger version of the image, information that describes the image, etc.

### SUMMARY

According to some possible implementations, a method may include storing, by one or more computer devices, information regarding a first cursor sequence that resulted in an occurrence of a hover event, and information regarding a second cursor sequence that did not result in an occurrence of the hover event, where the first cursor sequence and the second cursor sequence may identify a manner in which a particular cursor was moved relative to a display of a particular document. The method may also include obtaining, by the one or more computer devices, cursor information that identifies a manner in which a cursor is moved relative to a display of a document; comparing, by the one or more computer devices, the cursor information to the first cursor sequence and the second cursor sequence; determining, by the one or more computer devices and based on a result of comparing the cursor information to the first cursor sequence and the second cursor sequence, that the hover event occurred when the cursor information more closely matches the first cursor sequence than the second cursor sequence; and performing, by the one or more computer devices, an action based on determining that the hover event occurred.

Additionally, or alternatively, the method may include determining that the hover event did not occur when the cursor information more closely matches the second cursor sequence than the first cursor sequence; and precluding the action from being performed based on determining that the hover event did not occur.

Additionally, or alternatively, the method, when obtaining the cursor information, may include at least one of: obtaining information that identifies a location of the cursor, relative to the display of the document, as the cursor is moved with respect to the display of the document; obtaining information that identifies a velocity of the cursor, as the cursor is moved with respect to the display of the document; or obtaining information that identifies an acceleration of the cursor, as the cursor is moved with respect to the display of the document.

Additionally, or alternatively, the method may further include generating a sequence based on the cursor information, where the sequence may include at least one of: one or more first values that correspond to a horizontal location of the cursor, as a function of time, when the cursor is moved with respect to the display of the document; one or more second values that correspond to a vertical location of the cursor, as a function of time, when the cursor is moved with respect to the display of the document; one or more third values that correspond to a velocity of the cursor, as a function of time, when the cursor is moved with respect to the display of the document; or one or more fourth values that correspond to an acceleration of the cursor, when the cursor is moved with respect to the display of the document.

Additionally, or alternatively, the method, when comparing the cursor information to the first cursor sequence and the second cursor sequence, may include comparing the sequence to the first cursor sequence and the second cursor sequence to determine whether the sequence more closely matches the first cursor sequence or the second cursor sequence.

Additionally, or alternatively, the method, when comparing the sequence to the first cursor sequence and the second cursor sequence, may include calculating a first difference between the sequence and the first cursor sequence, calculating a second difference between the sequence and the second cursor sequence, and comparing the first difference and the second difference to determine whether the hover event occurred, where the hover event may occur when the first difference is smaller than the second difference.

Additionally, or alternatively, the method may include identifying a time period during which the cursor remains located over an area, within the display of the document, after the hover event occurred; and using the cursor information to update the information regarding the first cursor sequence when the time period satisfies a first threshold, using the cursor information to update the information regarding the second cursor sequence when the time period satisfies a second threshold, the second threshold being less than the first threshold, or using the cursor information to update neither the information regarding the first cursor sequence nor the information regarding the second cursor sequence when the time period is does not satisfy the first threshold or the second threshold.

According to some possible implementations, a computer-readable medium may include instructions which, when executed by one or more processors, cause the one or more processors to store information regarding a first cursor sequence that resulted in an occurrence of a hover event, and information regarding a second cursor sequence that did not result in an occurrence of the hover event, where the first cursor sequence and the second cursor sequence may identify a manner in which a particular cursor was moved relative to a display of a particular document; obtain cursor information that identifies a manner in which a cursor is moved relative to a display of a document; compare the cursor information to the first cursor sequence and the second cursor sequence; determine, based on a result of comparing the cursor information to the first cursor sequence and the second cursor sequence, that the hover event occurred when the cursor information more closely matches the first cursor sequence than the second cursor sequence; and perform an action based on determining that the hover event occurred.

Additionally, or alternatively, the instructions may further cause the one or more processors to determine that the hover event did not occur when the cursor information more closely matches the second cursor sequence than the first cursor sequence; and preclude the action from being performed based on determining that the hover event did not occur.

Additionally, or alternatively, the instructions, to obtain the cursor information, may cause the one or more processors to at least one of obtain information that identifies a location of the cursor, relative to the display of the document, as the cursor is moved with respect to the display of the document; obtain information that identifies a velocity of the cursor, as the cursor is moved with respect to the display of the document; or obtain information that identifies an acceleration of the cursor, as the cursor is moved with respect to the display of the document.

Additionally, or alternatively, the instructions may further cause the one or more processors to generate a sequence based on the cursor information, where the sequence may include at least one of: one or more first values that correspond to a horizontal location of the cursor, as a function of time, when the cursor is moved with respect to the display of the document; one or more second values that correspond to a vertical location of the cursor, as a function of time, when the cursor is moved with respect to the display of the document; one or more third values that correspond to a velocity of the cursor, as a function of time, when the cursor is moved with respect to the display of the document; or one or more fourth values that correspond to an acceleration of the cursor, when the cursor is moved with respect to the display of the document.

Additionally, or alternatively, the instructions, to compare the cursor information to the first cursor sequence and the second cursor sequence, may cause the one or more processors to compare the sequence to the first cursor sequence and the second cursor sequence to determine whether the sequence more closely matches the first cursor sequence or the second cursor sequence.

Additionally, or alternatively, the instructions, to compare the sequence to the first cursor sequence and the second cursor sequence, may cause the one or more processors to calculate a first difference between the sequence and the first cursor sequence, calculate a second difference between the sequence and the second cursor sequence, and compare the first difference and the second difference to determine whether the hover event occurred, where the hover event may occur when the first difference is smaller than the second difference.

Additionally, or alternatively, the instructions may further cause the one or more processors to identify a time period during which the cursor remains located over an area, within the display of the document, after the hover event occurred; and use the cursor information to update the information regarding the first cursor sequence when the time period satisfies a first threshold, use the cursor information to update the information regarding the second cursor sequence when the time period satisfies a second threshold, the second threshold being less than the first threshold, or use the cursor information to update neither the information regarding the first cursor sequence nor the information regarding the second cursor sequence when the time period is does not satisfy the first threshold or the second threshold.

According to some possible implementations, a system may include one or more computer devices to store information regarding a first cursor sequence that resulted in an occurrence of a hover event, and information regarding a second cursor sequence that did not result in an occurrence of the hover event, where the first cursor sequence and the second cursor sequence may identify a manner in which a particular cursor was moved relative to a display of a particular document; obtain cursor information that identifies a manner in which a cursor is moved relative to a display of a document; compare the cursor information to the first cursor sequence and the second cursor sequence; determine, based on a result of comparing the cursor information to the first cursor sequence and the second cursor sequence, that the hover event occurred when the cursor information more closely matches the first cursor sequence than the second cursor sequence; and perform an action based on determining that the hover event occurred.

Additionally, or alternatively, the one or more computer devices may further determine that the hover event did not occur when the cursor information more closely matches the second cursor sequence than the first cursor sequence; and preclude the action from being performed based on determining that the hover event did not occur.

Additionally, or alternatively, the one or more computer devices, when obtaining the cursor information, may obtain information that identifies a location of the cursor, relative to the display of the document, as the cursor is moved with respect to the display of the document; obtain information that identifies a velocity of the cursor, as the cursor is moved with respect to the display of the document; or obtain information that identifies an acceleration of the cursor, as the cursor is moved with respect to the display of the document.

Additionally, or alternatively, the one or more computer devices may further generate a sequence based on the cursor information, where the sequence may include at least one of: one or more first values that correspond to a horizontal location of the cursor, as a function of time, when the cursor is moved with respect to the display of the document; one or more second values that correspond to a vertical location of the cursor, as a function of time, when the cursor is moved with respect to the display of the document; one or more third values that correspond to a velocity of the cursor, as a function of time, when the cursor is moved with respect to the display of the document; or one or more fourth values that correspond to an acceleration of the cursor, when the cursor is moved with respect to the display of the document.

Additionally, or alternatively, the one or more computer devices, when comparing the cursor information to the first cursor sequence and the second cursor sequence, may calculate a first difference between the sequence and the first cursor sequence, calculate a second difference between the sequence and the second cursor sequence, and compare the first difference and the second difference to determine whether the hover event occurred, where the hover event may occur when the first difference is smaller than the second difference.

Additionally, or alternatively, the one or more computer devices may further identify a time period during which the cursor remains located over an area, within the display of the document, after the hover event occurred; and use the cursor information to update the information regarding the first cursor sequence when the time period satisfies a first threshold, use the cursor information to update the information regarding the second cursor sequence when the time period satisfies a second threshold, the second threshold being less than the first threshold, or use the cursor information to update neither the information regarding the first cursor sequence nor the information regarding the second cursor sequence when the time period is does not satisfy the first threshold or the second threshold.

The above discussion mentions examples in which some implementations may be implemented via one or more methods performed by one or more processors of one or more devices. In some implementations, one or more systems and/or one or more devices may be configured to perform one or more of the acts mentioned above. In some implementations, a computer-readable medium may include computer-executable instructions which, when executed by one or more processors, cause the one or more processors to perform one or more of the acts mentioned above.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIGS. 1A and 1B are diagrams illustrating an overview of some implementations described herein;

FIG. 2 is a diagram of an example environment in which technologies and/or techniques described herein may be implemented;

FIGS. 3A and 3B are flowcharts of example processes for generating a cursor sequence based on cursor movements within a search results document;

FIG. 4 is a diagram of an example data structure that stores a cursor sequence associated with a search session;

FIG. 5 is a flowchart of an example process for determining whether a cursor sequence, associated with a search session, is a non-triggering sequence or a triggering sequence;

FIG. 6 is a flowchart of an example process for detecting a hover event based on a cursor sequence associated with a search session;

FIGS. 7A-7D are graphs of example triggering sequences and non-triggering sequences associated with previous search sessions; and

FIG. 8 is a diagram of an example of a generic computer device and a generic mobile computer device.

### DETAILED DESCRIPTION

The following detailed description refers to the accompanying drawings. The same reference numbers in different drawings may identify the same or similar elements.

Technologies and/or techniques, as described herein, may enable a search system to obtain information that identifies a manner in which a user moves a cursor within a search results document that includes a set of images, to determine whether a hover event is detected. The system may generate a cursor sequence based on the information that identifies the manner in which the user moves the cursor. A hover event may be detected based on one or more known techniques, such as when a period of time that the cursor remains located over an image, hereinafter referred to as a “hover,” is greater than a first threshold. Detecting the hover event may cause the search system to perform one or more acts, such as providing an information window associated with the image and/or performing other acts to be described in greater detail below. The search system may monitor a period of time that the cursor hovers over the information window and may determine that the hover event should not have been detected, hereinafter referred to as a “short hover event,” when the period of time is less than a second threshold. The short hover event may, thus, correspond to a probability that the user did not intend the hover event to be detected. The search system may also, or alternatively, determine that the hover event should have been detected, hereinafter referred to as a “long hover event,” when the period of time is not less than the second threshold and/or is greater than a third threshold. The long hover event may, thus, correspond to a probability that the user intended the hover event to be detected. The search system may classify the cursor sequence, as a non-triggering sequence, when the period of time is less than the second threshold and may classify the cursor sequence, as a triggering sequence, when the period of time is not less than the second threshold and/or is greater than the third threshold.

The search system may also, or alternatively, monitor cursor movements within a search results document and may generate a cursor sequence based on information associated with the cursor movements. The search system may determine a first degree of match between the cursor sequence and a triggering sequence and a second degree of match between the cursor sequence and a non-triggering sequence. The triggering sequence may correspond to a previously obtained cursor sequence that is known to be associated with a long hover event. The non-triggering sequence may correspond to a previously obtained cursor sequence that is known to be associated with a short hover event. The search system may detect a hover event when the first degree of match is greater than the second degree of match and may perform the one or more acts based on detecting the hover event. Thus, the cursor sequence that caused the hover event to be detected, may indicate a probability, e.g., greater than 50% or some other threshold, that the user intended the hover event to be detected. The search system may not detect the hover event when the first degree of match is not greater than the second degree of match and may continue to monitor the cursor movements within the search results document. Thus, the cursor sequence, that did not cause the hover event to be detected, may indicate a probability, e.g., not greater than 50% or the other threshold, that the user did not intend the hover event to be detected. In this way, the user experience may be improved by reducing a frequency of performing the one or more acts when the user did not intend the one or more acts to be performed.

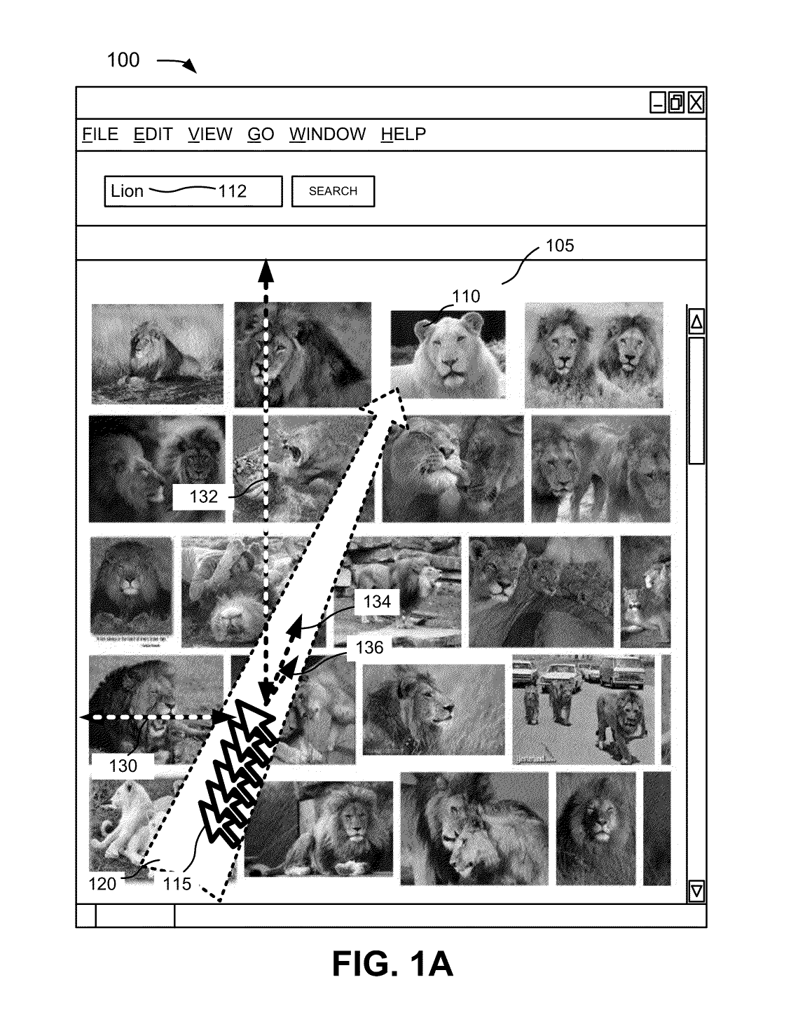

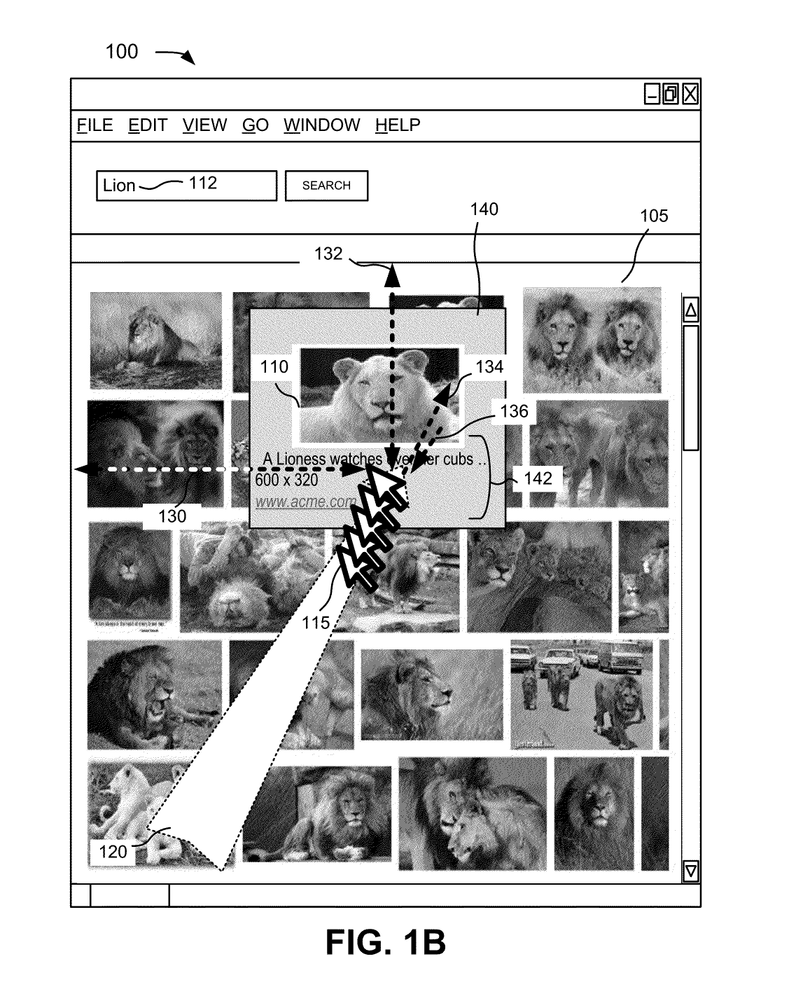

FIGS. 1A and 1B are diagrams illustrating an overview 100 of an example implementation described herein. As shown in FIG. 1A, example implementation 100 may include a search results document 105 that includes a set of images 110, hereinafter referred to collectively as “images 110” and individually as “image 110,” and a cursor 115. Search results document 105 may be provided by a search system, not shown, as a result of a search query 112, e.g., shown as “Lion,” received from a user. Images 110 may represent image results that are most relevant to search query 112 and/or are associated with a highest level of quality.

The user may use a pointing device, such as a mouse, a track ball, etc., to move cursor 115 within search results document 105. As cursor 115 moves, information associated with the movement of cursor 115, hereinafter referred to as “cursor information,” may, with the user's permission, be monitored by the system and/or by a user device on which search results document 105 is being displayed. For example, at a first point in time, the cursor information may identify a horizontal position 130, a vertical position 132, a velocity vector 134, an acceleration vector 136, etc. Horizontal position 130 may represent a location, of cursor 115, within search results document 105, relative to a left and/or right side of search results document 105. Vertical position 132 may represent a location, of cursor 115, within search results document 105, relative to a top and/or bottom side of search results document 105. Velocity vector 134 may represent a speed and/or direction that cursor 115 is moving within search results document 105. Acceleration vector 136 may represent a manner in which cursor 115 is accelerating, e.g., a rate of change of speed and/or direction, within search results document 105.

The system may generate a cursor sequence 120, e.g., represented by the dashed arrow, based on cursor information being collected as cursor 115 moves within search results document 105 during the search session. Cursor sequence 120 may represent the manner in which cursor 115 is being moved, by the user, within search results document 105.

As shown in FIG. 1B, example implementation 100 may include an information window 140 that is provided by the search system as a result of a hover event being detected. Information window 140 may include a particular image 110 on which detection of the hover event is based and/or image information 142 that includes information that describes the particular image 110, such as, for example, a snippet associated with particular image 110, a dimension of particular image 110, an address associated with particular image 110, and/or any other information associated with particular image 110. The search system may also, or alternatively, perform one or more other acts when a hover event is detected, such as providing a larger version, of particular image 110, than what existed prior to detecting the hover event; changing an appearance of the image, text, or information window, e.g., providing a border around the image, causing the image to be shadowed, causing borders or shading to blink, causing background colors to change, causing text to change color or become bold, etc.; causing a sound to be made; etc.

In the description below, the one or more acts are described as being associated with displaying an information window for simplicity. In some implementations, the one or more acts may include some or all of the acts described above and/or other acts not described above.

In an existing search system, the hover event may be detected when cursor 115 hovers over particular image 110 for a period of time that satisfies a threshold (e.g., is greater than the threshold). In example implementation 100, the search system may compare the cursor sequence to a triggering sequence, that is known to be associated with a long hover event, to identify a first degree of match between the cursor sequence and the triggering sequence. Additionally, or alternatively, the search system may compare the cursor sequence to a non-triggering sequence, that is known to be associated with a short hover event, to identify a second degree of match between the cursor sequence and the non-triggering sequence.

The search system may detect a hover event when the first degree of match is greater than the second degree of match and may cause one or more acts to be performed, such as, for example, providing information window 140. Additionally, or alternatively, the search system may not detect the hover event when the first degree of match is not greater than the second degree of match. In this example, the search system may cause information window 140 to be displayed. Additionally, or alternatively, the search system may determine whether to trigger the hover based on a combination of the first degree of match, the second degree of match, and a period of time during which cursor 115 hovers over the particular image 110.

Using the cursor sequence to detect a hover event may reduce a quantity of short hover events, e.g., hover events that are likely not to have been intended by the user, per search session and/or may increase a quantity of long hover events, e.g., hover events that are likely to have been intended by the user, per search session. Decreasing a frequency of short hover events and/or increasing a frequency of long hover events may improve the quality of the user experience during a search session.

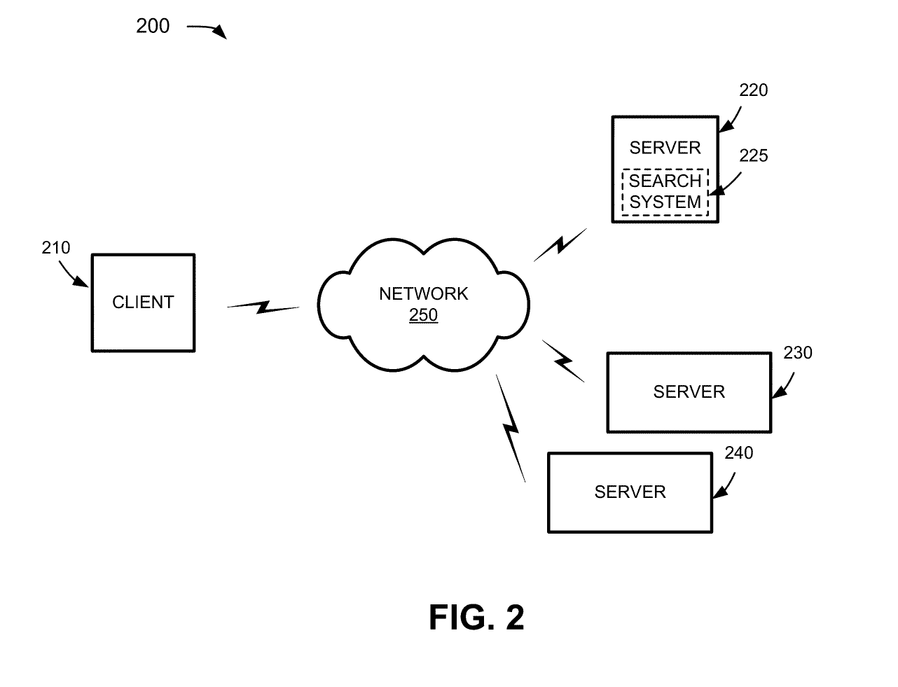

FIG. 2 is a diagram of an example environment 200 in which technologies and/or techniques described herein may be implemented. Environment 200 may include a client 210 connected to multiple servers 220, 230, and 240 via a network 250. One client 210, and three servers 220, 230, and 240, have been illustrated as connected to network 250 for simplicity. In practice, environment 200 may include additional clients, networks, and/or servers; fewer clients, networks, and/or servers; different clients, networks, and/or servers; or differently arranged clients, networks, and/or servers than are shown in environment 200. Also, in some instances, a client may perform a function of a server, and a server may perform a function of a client.

Client 210 may include a computer device, such as personal computer, a wireless telephone, a PDA, a laptop, a tablet computer, or another type of computation or communication device. Client 210 may include user interfaces presented through one or more browsers, e.g., web browsers. Client 210 may permit cursor information to be collected by search system 225 and/or provide cursor information to search system 225. A user of client 210 may elect to opt out from permitting access to the cursor information by search system 225 and/or providing the cursor information to search system 225. In some implementations, search system 225 may be installed and/or hosted by client 210, which may enable search results, obtained from a memory associated with client 210, that are responsive to a search query provided by a user of client 210. Search system 225 is described in greater detail below.

Servers 220, 230, and 240 may include server devices that gather, process, search, and/or perform functions in a manner described herein. Each server 220, 230, or 240 may be implemented as a single server device or a collection of server devices that may be co-located or remotely located. Additionally, or alternatively, any two or more of servers 220, 230, and 240 may be implemented within a single, common server device or a single, common collection of server devices. While servers 220, 230, and 240 are shown as separate components, it may be possible for one or more of servers 220, 230, and/or 240 to perform one or more of the functions of another one or more of servers 220, 230, and/or 240.

As shown in FIG. 2, server 220 may implement a search system 225 that receives a search query from client 210, and provides search results that are responsive to the search query. The search results may, in some examples, include a set of images that are responsive to the search query. Server 220 may crawl a corpus of documents, e.g., web documents, index the documents, and store information associated with the documents in a repository of documents. In some examples, server 220 may identify an image within a document and may store information associated with the image in a repository of images. Server 220 may also, or alternatively, crawl a corpus of images, index the images, and store information, associated with the images, in the repository of images. Servers 230 and 240 may store or maintain documents and/or images that may be crawled or analyzed by server 220. Server 220 may monitor cursor movements associated with client 210 to identify a cursor sequence and may determine whether a hover event is detected based on the cursor sequence relative to one or more triggering sequences or non-triggering sequences.

Network 250 may include any type of network, such as a local area network, “LAN,” a wide area network, “WAN,” a telephone network, such as the Public Switched Telephone Network, “PSTN,” or a cellular network, an intranet, the Internet, or a combination of networks. Client 210 and servers 220, 230, and 240 may connect to network 250 via wired and/or wireless connections. In other words, any one of client 210 and servers 220, 230, and 240 may connect to network 250 via a wired connection, a wireless connection, or a combination of a wired connection and a wireless connection.

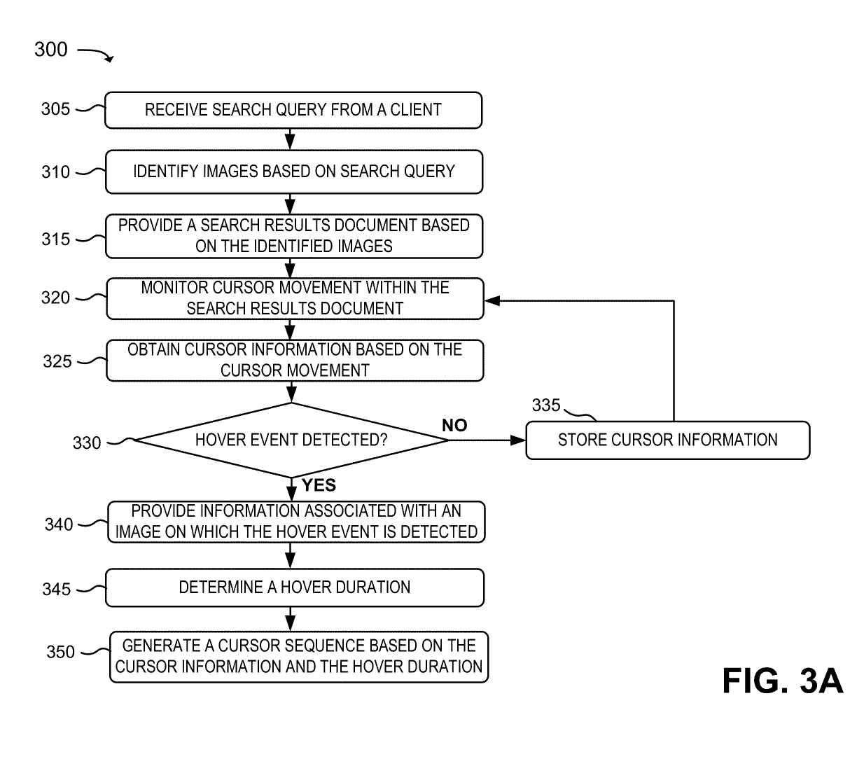

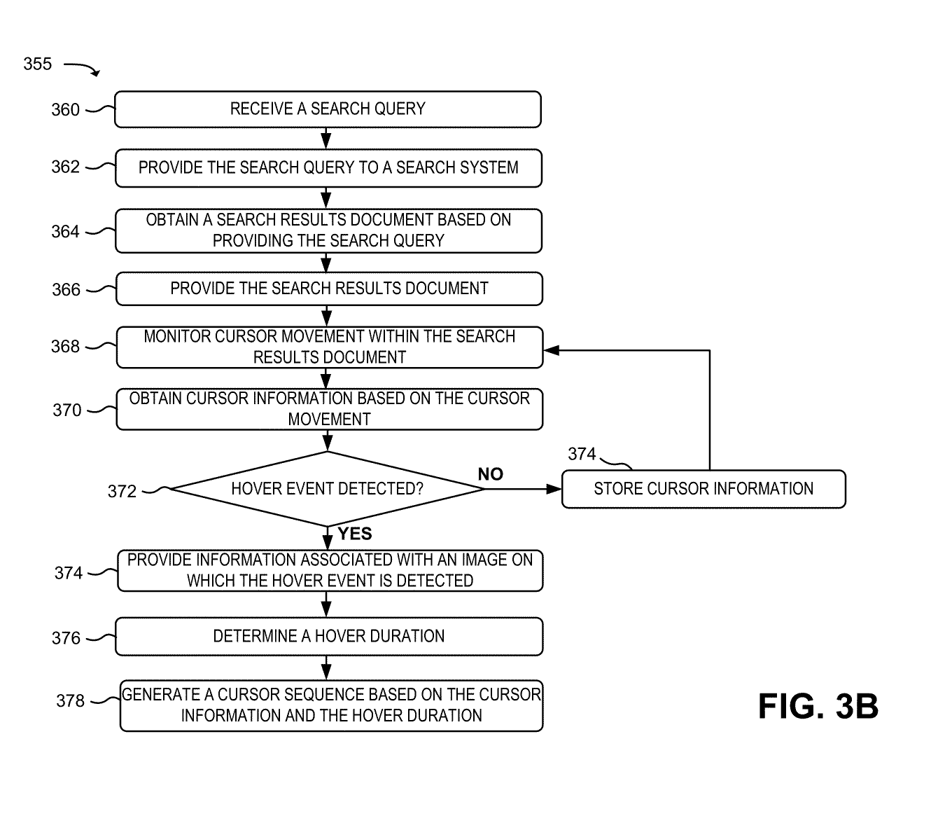

FIG. 3A is a flowchart of an example process 300 for generating a cursor sequence based on cursor movements within a search results document. In some implementations, process 300 may be performed by server 220. In some other implementations, process 300 may be performed by one or more other devices instead of, or possibly in conjunction with, server 220. For example, some or all of process 300 may be performed by client 210 and/or server 230 or 240.

As shown in FIG. 3A, process 300 may include receiving a search query from a client (block 305) and identifying images based on the search query (block 310). For example, a user, of client 210 may use a browser to access a user interface of search system 225 to initiate a search session. Via the user interface, the user may, for example, enter a search query. Client 210 may transmit the search query to search system 225 and search system 225 may receive the search query from client 210.

Search system 225 may use one or more known techniques to perform a search of one or more image indexes that are maintained by server 220 and/or one or more of servers 230 and 240 to obtain image results that are relevant to the search query. The known techniques may, for example, identify image results based on measures of relevance of the image results to the search query, measures of quality associated with the image results, etc. Each image result may include an image, e.g., a thumbnail image, etc., and/or image information that describes the image. The image information may, for example, include a snippet of text associated with the image; an address from which the image can be obtained, e.g., a larger or higher resolution version of the thumbnail image, etc.; dimensions of the image; a resolution level of the image; an owner of the image; etc.

As also shown in FIG. 3A, process 300 may include providing a search results document based on the identified images (block 315). For example, search system 225 may rank the image results and may select image results based on the ranking. Search system 225 may, for example, process the image results, based on the measures of relevance of the image results to the search query and/or based on the measures of quality of the image results. Search system 225 may, for example, rank the image results based on the measures of relevance and/or the measures of quality.

Search system 225 may also, or alternatively, generate scores for the image results based on the measures of relevance to the search query and/or the measures of quality. In some implementations, the score, for an image result, may reflect a measure of relevance of the corresponding image to one or more of the terms of the search query. Several techniques exist for measuring the relevance of an image to a search query.

In some other implementations, the score, for an image result, may reflect a measure of quality of the corresponding image. In these other implementations, the search query may be used to identify a relevant image, which is scored based on the image's measure of quality. Several techniques exist for measuring the quality of an image result, such as a link-based technique; a technique based on the source of the image; a technique based on an age of the image; a technique based on user selections relating to the image; a technique based on a size, resolution, aspect ratio, etc., relating to the image; etc. In some further implementations, the score, for an image result, may reflect a combination of a measure of relevance of the corresponding image to a search query and a measure of quality of the corresponding image. In some other implementations, the score, for an image result, may reflect a weighted combination of a measure of relevance of the corresponding image to a search query and a measure of quality of the corresponding image, where the measure of relevance may be weighted differently from the measure of quality. In some further implementations, the score, for an image result, may be determined in another manner.

Search system 225 may rank the image results based on the scores. For example, search system 225 may create a list of image results and sort the image results, in the list, based on the scores of the image results. Search system 225 may select image results based on the scores, e.g., select those image results with the top 10 scores, the top 20 scores, the top 50 scores, etc., and may generate a search results document based on the selected image results. Search system 225 may provide the search results document to client 210.

As further shown in FIG. 3A, process 300 may include monitoring cursor movement within the search results document (block 320) and obtaining cursor information based on the cursor movement (block 325). For example, client 210 may receive the search results document and may display the search results document, such as search results document 105 of FIGS. 1A and 1B, on client 210. A user, of client 210, may use a pointing device to move a cursor, e.g., cursor 115, within the search results document. Search system 225 may monitor the manner in which cursor is moving within the search results document. Additionally, or alternatively, client 210 may monitor the manner in which the cursor is moving within the search results document and may provide information, identifying the manner in which the cursor is moving, to search system 225. A user, of client 210, may opt out of the monitoring, which may preclude search system 225 from monitoring the cursor movement and/or may preclude client 210 from providing information, identifying the manner in which the cursor is moving, to search system 225.

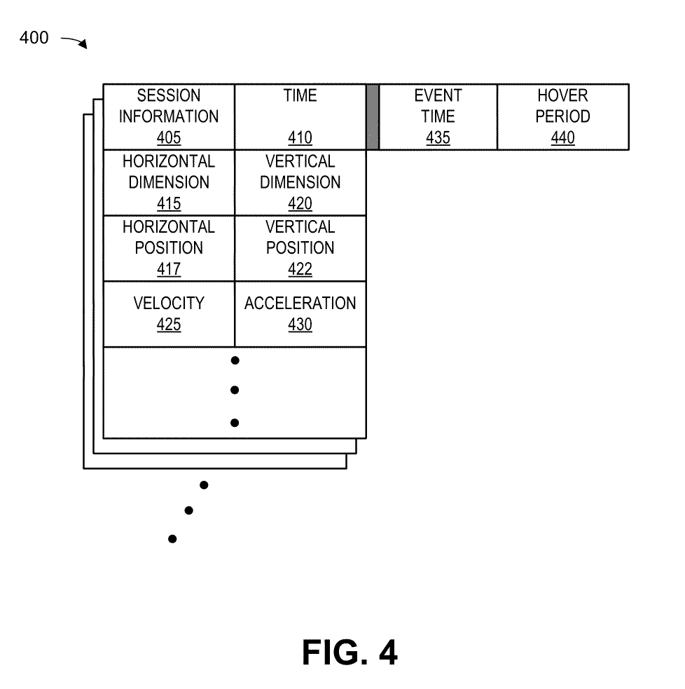

In some implementations, search system 225 may identify a first location of the cursor, within the search results document, at a first point in time. In some examples, the first location may be specified by the cursor's horizontal position, to be described in greater detail below with respect to FIG. 4, within the search results document based on, for example, a distance from a left edge or a right edge of the search results document. Additionally, or alternatively, the first location may be specified by the cursor's vertical position, to be described in greater detail below with respect to FIG. 4, within the search results document, based on, for example, a distance from a top edge or a bottom edge of the search results document. Other techniques may be used to identify the cursor's location, such as determining a location relative to a center point of the search results document, one or more corners of the search results document, and/or some other location within a desktop, associated with client 210, that is within, or outside, the search results document.

Additionally, or alternatively, search system 225 may identify a first velocity of the cursor at the first point in time. In this example, search system 225 may identify an instantaneous speed and/or direction of movement of the cursor within the search results document. The velocity of the cursor will be described in greater detail below with respect to FIG. 4. Additionally, or alternatively, search system 225 may identify a first acceleration of the cursor at the first point in time. In this example, search system 225 may identify an instantaneous rate at which the speed of the cursor is changing, e.g., speeding up, slowing down, etc., and/or an instantaneous rate at which the direction of the cursor is changing within the search results document. The acceleration of the cursor will be described in greater detail below with respect to FIG. 4. Search system 225 may obtain first cursor information, at the first point in time, based on the first location of the cursor, the first velocity of the cursor, and/or the first acceleration of the cursor. Additionally, or alternatively, search system 225 may obtain other cursor information associated with a sustained turn rate of the cursor, an instantaneous turn rate of the cursor, etc.

Search system 225 may obtain second cursor information at a second point in time that identifies a second location, a second velocity, and/or a second acceleration of the cursor, within the search results document, at the second point in time. Search system 225 may also, or alternatively, identify combined cursor information over a time period, from the first point in time to the second point in time, based on a combination of the first cursor information and the second cursor information. For example, a combined location may be based on a combination, e.g., an average, a mean, etc., of the first location and the second location; a combined velocity may be based on a combination of the first velocity and the second velocity; a combined acceleration may be based on a combination of the first acceleration and the second acceleration; etc. Search system 225 may continue to collect cursor information, e.g., every thousandth of a second, every hundredth of a second, every tenth of a second, every second, etc., as the cursor continues to move within the search results document.

As yet further shown in FIG. 3A, if a hover event is not detected (block 330-NO), process 300 may include storing the cursor information (block 335) and continuing to monitor the client cursor movement within the search results document (block 320). For example, search system 225 may determine a period of time, sometimes referred to as a “dwell period,” during which the cursor hovers over a particular image within the search results document. When the dwell period does not satisfy a dwell threshold, e.g., is not greater than 0.1 seconds, 0.25 seconds, 0.5 seconds, 1 second, etc., search system 225 may not detect a hover event. The dwell threshold may be predetermined by server 220 and/or may be specified by an operator of server 220. When the hover event is not detected, search system 225 may store the cursor information in a memory associated with server 220 and/or servers 230 and/or 240. Additionally, or alternatively, when the hover event is not detected, search system 225 may continue to monitor and collect cursor information as the cursor continues to move within the search results document.

As still further shown in FIG. 3A, if the hover event is detected (block 330—YES), process 300 may include providing information associated with an image on which the hover event is detected (block 340). For example, search system 225 may determine that the cursor is located over the particular image for a dwell period that satisfies the dwell threshold, e.g., is greater than the dwell threshold. When the dwell period satisfies the dwell threshold, search system 225 may detect the hover event associated with the particular image. When the hover event is detected, search system 225 may perform one or more acts, such as causing an information window, e.g., information window 140, to be displayed within the search results document. The information window may include the particular image and/or image information associated with the particular image.

As also shown in FIG. 3A, process 300 may include determining a duration of the hover (block 345) and generating a cursor sequence based on the cursor information and the duration of the hover (block 350). For example, search system 225 may continue to monitor cursor movement, within the search results document, after the hover event is detected. For example, search system 225 may determine a period of time during which the cursor remains located within the information window, hereinafter referred to as “hover period,” before being moved to another location that is outside the information window. Search system 225 may also, or alternatively, generate a cursor sequence based on the cursor movements prior to detecting the hover event and/or during the hover period. Search system 225 may store the cursor sequence in a memory associated with server 220 and/or servers 230 and/or 240.

FIG. 3B is a flowchart of an example process 355 for generating a cursor sequence based on cursor movements within a search results document. In some implementations, process 355 may be performed by client 210. In some other implementations, process 355 may be performed by one or more other devices instead of, or possibly in conjunction with, client 210.

As shown in FIG. 3B, process 355 may include receiving a search query (block 360) and providing the search query to a search system (block 362). For example, a user, of client 210, may provide a search query to client 210 to initiate a search session. In one example, the user may provide the search query via a user interface associated with search system 225. Client 210 may receive the search query (e.g., via the user interface) and may provide the search query to server 220 on which search system 225 is hosted. Server 220 may receive the search query from client 210.

Search system 225 may, in a manner similar to that described above with respect to block 310 and 315 of FIG. 3A, use one or more of the known techniques to obtain image results that are relevant to the search query. Each image result may include an image, e.g., a thumbnail image, etc., and/or image information that describes the image. The image information may, for example, include a snippet of text associated with the image; an address from which the image can be obtained, e.g., a larger or higher resolution version of the thumbnail image, etc.; dimensions of the image; a resolution level of the image; an owner of the image; etc.

Search system 225 may also, or alternatively, rank the image results and may select image results based on the ranking. Search system 225 may also, or alternatively, generate scores for the image results based on measures of relevance to the search query, measures of quality, and/or some other known technique. Search system 225 may select image results based on the ranking and/or the scores, e.g., select those image results with the top 10 scores, the top 20 scores, the top 50 scores, etc., and may generate a search results document based on the selected image results. Search system 225 may provide the search results document to client 210.

In some implementations, client 210 may host search system 225. For example, client 210 may use search system 225 to obtain the image results from an index of images that are stored in a memory associated with client 210 and/or servers 230 and/or 240. In this example, client 210 may not transmit the search query to server 220. Search system 225 may rank and/or select the image results in a manner similar to that described above. Search system 225 may generate a search results document that includes the selected image results.

As also shown in FIG. 3B, process 355 may include obtaining a search results document based on providing the search query (block 364) and providing the search results document for display (block 366). For example, client 210 may receive the search results document from server 220. Additionally, or alternatively, client 210 may obtain the search results document that is generated by search system 220 that is hosted by client 210. Client 210 may display the search results document, such as search results document 105 of FIGS. 1A and 1B, on client 210.

As further shown in FIG. 3B, process 355 may include monitoring cursor movement within the search results document (block 368) and obtaining cursor information based on the cursor movement (block 370). For example, client 210 may use search system 225, hosted by client 210, to monitor cursor movements, performed by the user, within the search results document. Additionally, or alternatively, client 210 may provide, to server 220, information identifying a manner in which the cursor is moving within the search results document. A user, of client 210, may opt out of the monitoring, which may preclude search system 225 from monitoring the cursor movements and/or from providing the information, identifying the manner in which the cursor is moving, to search system 225.

Client 210 may, in a manner similar to that described above with respect to block 320 of FIG. 3A, use search system 225 to identify a first location of the cursor, within the search results document, at a first point in time (e.g., associated with a horizontal position, a vertical position, etc. within the search results document). Additionally, or alternatively, search system 225 may identify a first velocity and/or first acceleration of the cursor at the first point in time. Search system 225 may obtain first cursor information, at the first point in time, based on the first location of the cursor, the first velocity of the cursor, and/or the first acceleration of the cursor. Additionally, or alternatively, search system 225 may obtain other cursor information associated with a sustained turn rate of the cursor, an instantaneous turn rate of the cursor, etc.

Client 210 may, in a manner similar to that described above with respect to block 320 of FIG. 3A, use search system 225 to obtain second cursor information at a second point in time that identifies a second location, a second velocity, and/or a second acceleration of the cursor, within the search results document, at the second point in time. Search system 225 may also, or alternatively, identify combined cursor information over a time period, from the first point in time to the second point in time, based on a combination of the first cursor information and the second cursor information. For example, a combined location may be based on a combination, e.g., an average, a mean, etc., of the first location and the second location; a combined velocity may be based on a combination of the first velocity and the second velocity; a combined acceleration may be based on a combination of the first acceleration and the second acceleration; etc. Search system 225 may continue to collect cursor information, e.g., every thousandth of a second, every hundredth of a second, every tenth of a second, every second, etc., as the cursor continues to move within the search results document.

As yet further shown in FIG. 3B, if a hover event is not detected (block 372-NO), process 355 may include storing the cursor information (block 374) and continuing to monitor the client cursor movement within the search results document (block 368). For example, client 210 may use search system 225 to determine a dwell period during which the cursor hovers over a particular image within the search results document. When the dwell period does not satisfy a dwell threshold, e.g., is not greater than 0.1 seconds, 0.25 seconds, 0.5 seconds, 1 second, etc., search system 225 may not detect a hover event. The dwell threshold may be predetermined by client 210 and/or search system 225. When the hover event is not detected, search system 225 may store the cursor information in a memory associated client 210. Client device 210 may also, or alternatively, provide the cursor information to server 220 and/or servers 230 and/or 240. Additionally, or alternatively, when the hover event is not detected, client 210 may use search system 225 to continue monitoring and collecting cursor information as the cursor continues to move within the search results document.

As still further shown in FIG. 3B, if the hover event is detected (block 372—YES), process 355 may include providing information associated with an image on which the hover event is detected (block 374). For example, client 210 may, in a manner similar to that described above with respect to block 330, use search system 225 to determine that the cursor is located over the particular image for a dwell period that satisfies the dwell threshold, e.g., is greater than the dwell threshold. When the dwell period satisfies the dwell threshold, search system 225 may detect the hover event associated with the particular image. When the hover event is detected, search system 225 may perform one or more acts, such as causing an information window, e.g., information window 140, to be displayed within the search results document. The information window may include the particular image and/or image information associated with the particular image.

As also shown in FIG. 3B, process 355 may include determining a duration of the hover (block 376) and generating a cursor sequence based on the cursor information and the duration of the hover (block 378). For example, client 210 may use search system 225 to continue to monitor cursor movement, within the search results document, after the hover event is detected. For example, search system 225 may determine a hover period during which the cursor remains located within the information window before being moved to another location that is outside the information window. Search system 225 may also, or alternatively, generate a cursor sequence based on the cursor movements prior to detecting the hover event and/or during the hover period. Search system 225 may store the cursor sequence in a memory associated with client 210. Additionally, or alternatively, client 210 may provide the cursor sequence to server 220 and/or servers 230 and/or 240.

FIG. 4 is a diagram of an example data structure 400 that stores a cursor sequence associated with a search session. Data structure 400 may be stored in a memory associated with one or more of servers 220-240. Data structure 400 may include a collection of fields, such as a session information field 405, a time field 410, a horizontal dimension field 415, a horizontal position field 417, a vertical dimension field 420, a vertical position field 422, a velocity field 425, an acceleration field 430, an event time field 435, and a hover period field 440. Fields 405-440, included within data structure 400, are provided for explanatory purposes. In other implementations, data structure 400 may include additional fields, fewer fields, different fields, or differently arranged fields than are shown with respect to FIG. 4.

Session information field 405 may store information, e.g., a session identifier, etc., that identifies a particular search session between client 210 and search system 225. Time field 410 may store information that identifies one or more points in time that cursor information is collected in a time period associated with the particular session. For example, time field 410 may store a first time value, e.g., t1, that corresponds to a first time at which first cursor information is collected; a second time value, e.g., t2, that corresponds to a second time at which second cursor information is collected; a third time value, e.g., t3, that corresponds to a third time at which third cursor information is collected; and so on.

Horizontal dimension field 415 may store information associated with a horizontal dimension of a search results document based on, for example, a pixel count; a distance, e.g., inches, centimeters, etc.; etc. Horizontal position field 417 may store information that identifies one or more instantaneous horizontal positions of a cursor, e.g., horizontal positions 130, within a search results document, e.g., search results document 105, during the time period associated with the particular session. For example, horizontal position field 417 may store a first horizontal value, e.g., x1 and x, at a first time, e.g., t1. The first horizontal value may, for example, correspond to a first instantaneous horizontal position, e.g., x1, of the cursor relative to a reference location, e.g., a left edge, a right edge, etc. of the search results document, within the horizontal dimension, e.g., x, identified by horizontal dimension field 415. Additionally, or alternatively, horizontal position field 417 may store a second horizontal value, e.g., x2, x, that corresponds to a second horizontal position, of the cursor, at the second time, e.g., t2, identified by time field 410; a third horizontal value, e.g., x3, x, that corresponds to a third horizontal position, of the cursor, at the third time, e.g., t3, identified by time field 410; and so on. Horizontal position field 417 may, thus, store a horizontal sequence that includes one or more of the horizontal values associated with the particular session, identified by session ID field 405, associated with the search results document.

Vertical dimension field 420 may store information associated with a vertical dimension of a search results document, e.g., y, based on, for example, a pixel count, a length, etc. Vertical position field 422 may store information that identifies one or more instantaneous vertical positions of the cursor, e.g., vertical positions 132, within the search results document, during the time period associated with the particular session. For example, vertical position field 422 may store a first vertical value, e.g., y1 and y, at the first time. The first vertical value may, for example, correspond to a first instantaneous vertical position, e.g., y1, of the cursor relative to a reference location, e.g., a top edge, a bottom edge, etc. of the search results document, within the vertical dimension, e.g., y, identified by vertical dimension field 420. Additionally, or alternatively, vertical position field 422 may store a second vertical value, e.g., y2, y, that corresponds to a second vertical position, of the cursor, at the second time, e.g., t2, identified by time field 410; a third vertical value, e.g., y3, y, that corresponds to a third vertical position, of the cursor, at a third time, t3, identified by time field 410; and so on. Vertical position field 422 may, thus, store a vertical sequence that includes one or more of the vertical values associated with the particular session.

Velocity field 425 may store information that identifies one or more instantaneous velocities of the cursor, e.g., velocity vector 134, within the search results document, during the time period associated with the particular session. For example, velocity field 425 may store a first velocity value, e.g., v1, that corresponds to a first velocity of the cursor, within the search results document, at the first time. The first velocity may, for example, correspond to a speed, e.g., centimeters/second, inches/second, etc.; and/or a direction that the cursor is moving, at the first time, within the search results document. Additionally, or alternatively, velocity field 425 may store a second velocity value, e.g., v2, that corresponds to a second velocity, of the cursor, at the second time; a third velocity value, e.g., v3, that corresponds to a third velocity, of the cursor, at the third time; and so on. Velocity field 425 may, thus, store a velocity sequence that includes one or more of the velocity values associated with the particular session.

Acceleration field 430 may store information that identifies one or more instantaneous accelerations of the cursor, e.g., acceleration vector 136, within the search results document, during the time period associated with the particular session. For example, acceleration field 430 may store a first acceleration value, e.g., a1, that corresponds to a first acceleration of the cursor, within the search results document, at the first time. The first acceleration may, for example, correspond to a rate at which a speed and/or a direction of the cursor is changing, e.g., in centimeters/second, inches/second², etc., at the first time, within the search results document. Additionally, or alternatively, acceleration field 430 may store a second acceleration value, e.g., a2, that corresponds to a second acceleration, of the cursor, at the second time; a third acceleration value, e.g., a3, that corresponds to a third acceleration, of the cursor, at the third time; and so on. Acceleration field 430 may, thus, store an acceleration sequence that includes one or more of the acceleration values associated with the particular session.

Event time field 435 may store information that identifies a time, within the time period associated with the session, that a hover event is detected. For example, the cursor may be located over an image, within the search results document, for a dwell period that satisfies a dwell threshold, e.g., is greater than the dwell threshold. The time at which search system 225 determines that the dwell period satisfies the dwell threshold, may correspond to an event time at which the hover event is detected. Hover period field 440 may store information that identifies a hover period, associated with the cursor, that is located over an information window, an image, and/or some other object being displayed, e.g., as a result of the hover event being detected, before being moved to another location that is not within the information window, the image, or the other object.

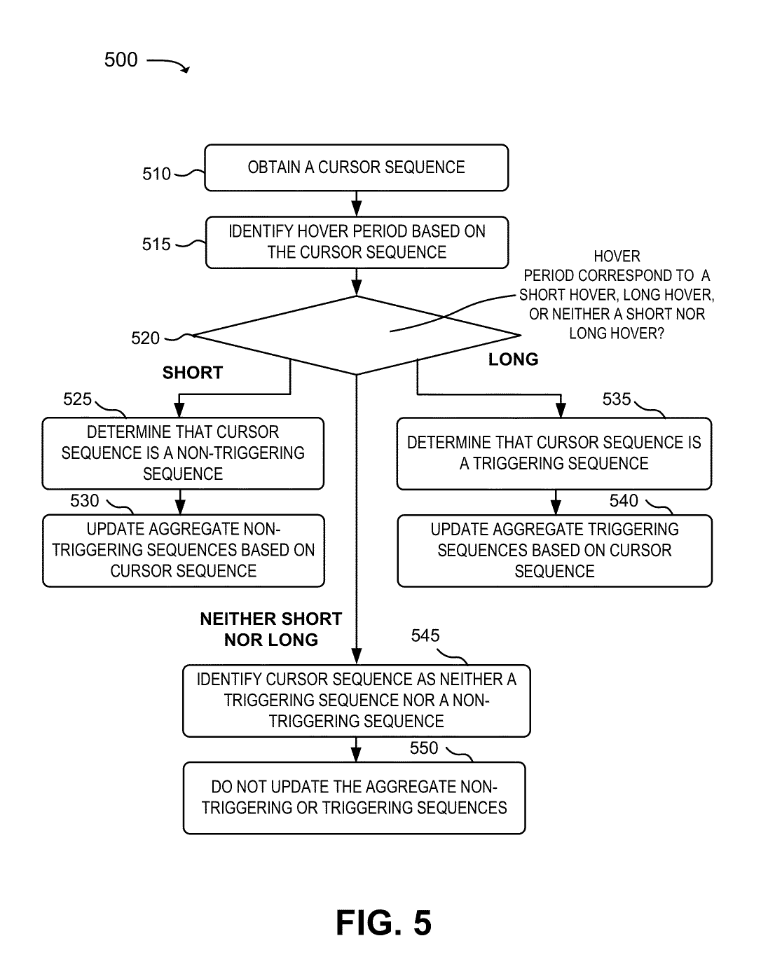

FIG. 5 is a flowchart of an example process 500 for determining whether a cursor sequence, associated with a search session, is a non-triggering sequence or a triggering sequence. In some implementations, process 500 may be performed by server 220. In some other implementations, process 500 may be performed by one or more other devices instead of, or possibly in conjunction with, server 220. For example, some or all of process 500 may be performed by server 230 or 240. Additionally, or alternatively, one or more steps of process 500 may be performed on a near real-time basis during a search session and/or in an offline manner after the search session is concluded.

As shown in FIG. 5, process 500 may include obtaining a cursor sequence (block 510) and identifying a hover period based on the cursor sequence (block 515). For example, search system 225 may obtain a cursor sequence associated with a search session. In some examples, search system 225 may obtain the cursor sequence, in an online manner similar to that described above with respect to process 300 of FIG. 3A. Additionally, or alternatively, search system 225 may obtain the cursor sequence, in an offline manner, from a data structure, e.g., data structure 400 of FIG. 4, stored within a memory associated with server 220, server 230, and/or server 240. Additionally, or alternatively, search system 225 may obtain, from the data structure, information that identifies a hover period associated with the cursor sequence, as a result of detecting a hover event.

As also shown in FIG. 5, if the hover period corresponds to a short hover (block 520—SHORT), process 500 may include determining that the cursor sequence is a non-triggering sequence (block 525) and updating aggregate non-triggering sequences based on the cursor sequence (block 530). For example, search system 225 may compare the hover period to a first threshold. When the hover period satisfies the first threshold, e.g., is less than the first threshold, search system 225 may determine that the hover period corresponds to a short hover event. The short hover event may indicate that the user did not intend for a hover event to be detected.

When the hover period corresponds to the short hover, search system 225 may also, or alternatively, determine that the cursor sequence is a non-triggering sequence. For example, search system 225 may update aggregate non-triggering sequences, stored in a memory, based on the cursor sequence. Search system 225 may, for example, store, in the memory, the cursor sequence in a data structure that stores other non-triggering sequences.

As further shown in FIG. 5, if the hover period corresponds to a long hover (block 520—LONG), process 500 may include determining that the cursor sequence is a triggering sequence (block 535) and updating aggregate triggering sequences based on the cursor sequence (block 540). For example, search system 225 may compare the hover period to a second threshold that is greater than the first threshold. When the hover period satisfies the second threshold, e.g., is greater than the second threshold, search system 225 may determine that the hover period corresponds to a long hover event. The long hover may indicate that the user intended for a hover event to be detected.

When the hover period corresponds to the long hover, search system 225 may also, or alternatively, determine that the cursor sequence is a triggering sequence. For example, search system 225 may update aggregate triggering sequences, stored in a memory, based on the cursor sequence. Search system 225 may, for example, store, in the memory, the cursor sequence in a data structure that stores other triggering sequences.

As still further shown in FIG. 5, if the hover period does not correspond to the short hover or the long hover (block 520—NEITHER SHORT NOR LONG), process 500 may include determining that the cursor sequence is neither a non-triggering sequence nor a triggering sequence (block 545) and not updating the aggregate non-triggering or triggering sequences (block 550). For example, search system 225 may determine that the hover period does not satisfy the first threshold and does not satisfy the second threshold. When the hover period does not satisfy the first threshold and does not satisfy the second threshold, search system 225 may determine that the hover period does not correspond to a short hover event or a long hover event. Based on the determination that the hover period does not correspond to the short hover event or a long hover event, search system 225 may not update the aggregate non-triggering sequences or the aggregate triggering sequences, respectively, based on the cursor sequence. In some examples, search system 225 may discard the cursor sequence.

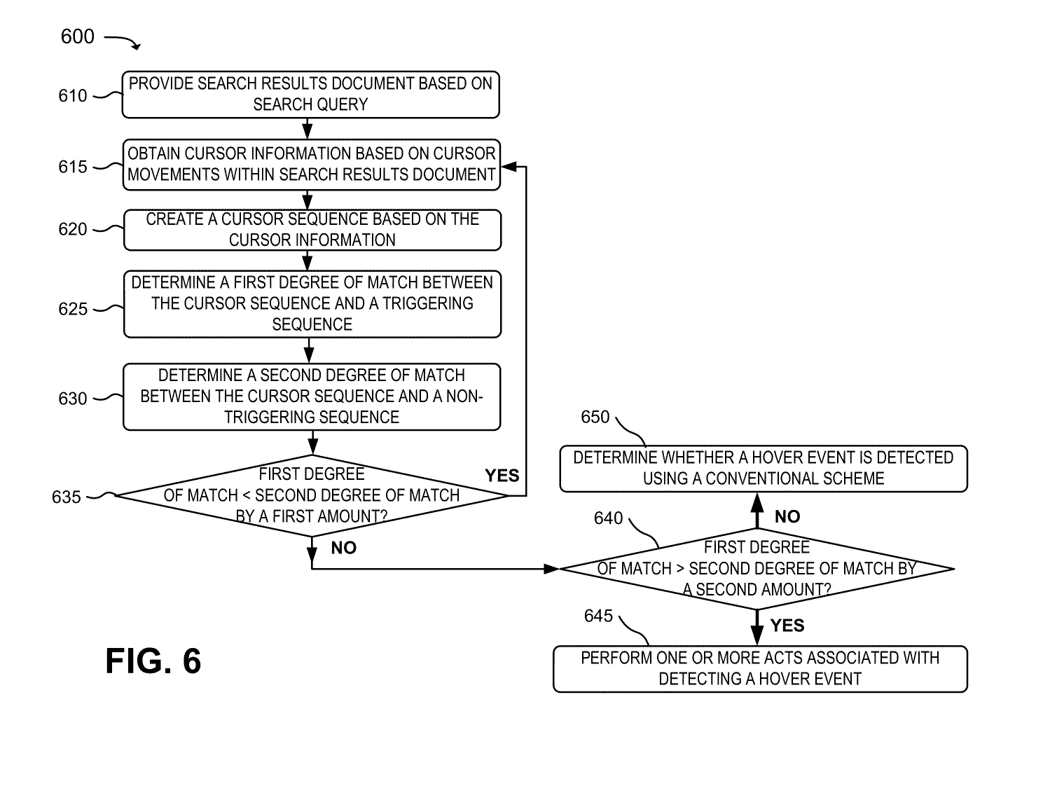

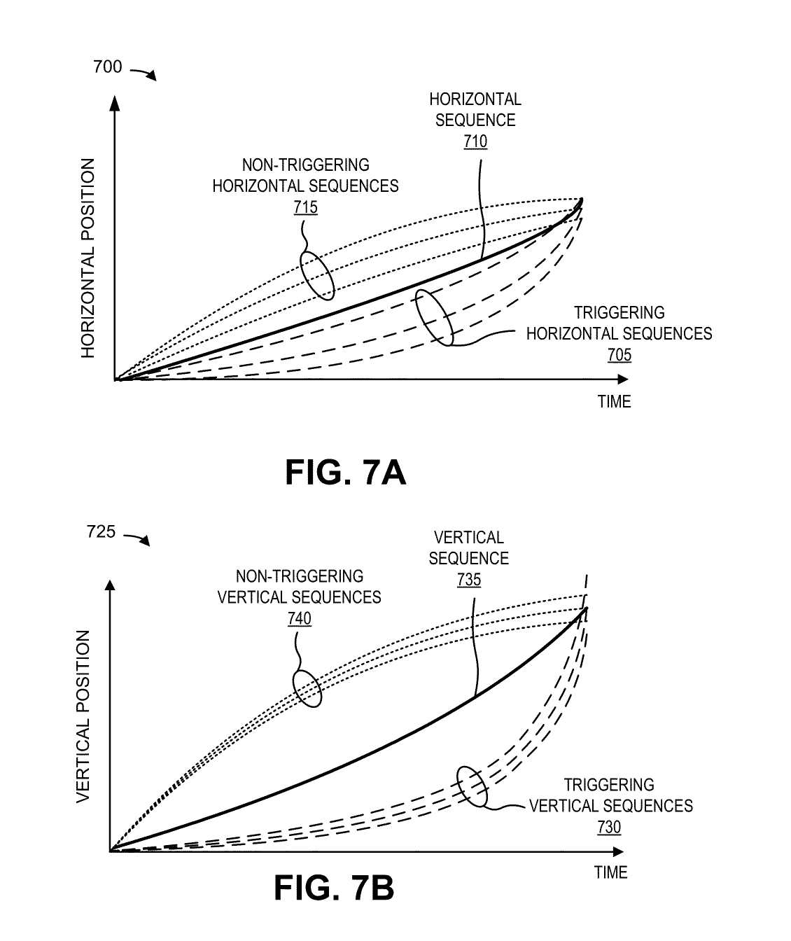

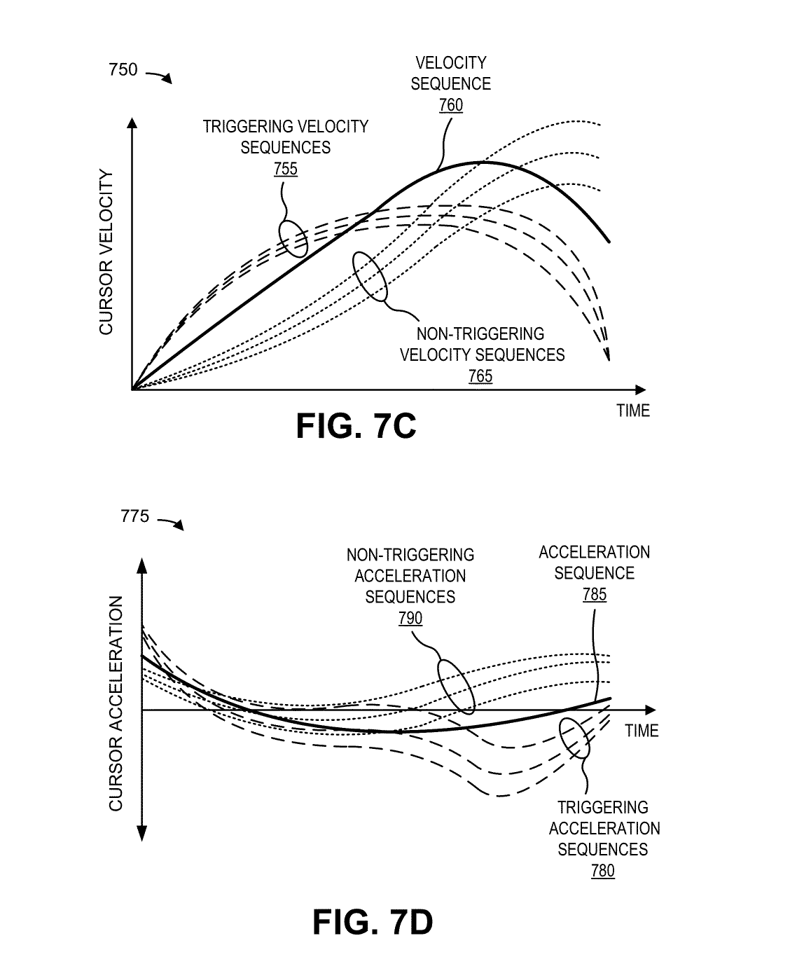

FIG. 6 is a flowchart of an example process 600 for detecting a hover event based on a cursor sequence associated with a search session. In some implementations, process 600 may be performed by server 220. In other implementations, process 600 may be performed by one or more other devices instead of, or possibly in conjunction with, server 220. For example, some or all of process 600 may be performed by client 210 or server 230 or 240. FIGS. 7A-7D are graphs of example triggering sequences and non-triggering sequences associated with previous search sessions. In the description below, all or a portion of process 600 of FIG. 6 will be described with references to FIGS. 7A-7D.

As shown in FIG. 6, process 600 may include providing a search results document based on a search query (block 610) and obtaining cursor information based on cursor movements within the search results document (block 615). For example, search system 225 may, in a manner similar to that described above with respect to blocks 305-315 of FIG. 3A, receive a search query from client 210, may obtain image results that are relevant to the search query, and/or may provide a search results document, to client 210, that includes all or a portion of the image results. Client 210 may receive the search results document and may display the search results document on client 210.

Additionally, or alternatively, search system 225 may, in a manner similar to that described above with respect to blocks 320 and 325 of FIG. 3A, monitor cursor movements within the search results document and may obtain, from client 210, cursor information based on the cursor movements within the search results document. The cursor information may, as described above, include a set of values associated with cursor location; a set of values associated with cursor velocity; a set of values associated with cursor acceleration; etc. that correspond to a set of time values within a period of time of the search session.

As also shown in FIG. 6, process 600 may include generating a cursor sequence based on the cursor information (block 620) and determining a first degree of match between the cursor sequence and a triggering sequence (block 625). For example, search system 225 may generate a cursor sequence based on the cursor information and may compare the cursor sequence to one or more triggering sequences that are known to be associated with a long hover event. The cursor sequence may, in a manner similar to that described above with respect to FIG. 4, include one or more component sequences, such as a location sequence that includes, for example, a horizontal sequence, e.g., based on x1, x2, x3, etc. and/or a vertical sequence, e.g., based on y1, y2, y3, etc.; a velocity sequence, e.g., based on v1, v2, v3, etc.; an acceleration sequence, e.g., based on a1, a2, a3, etc.; etc. relative to a set of time values, e.g., t1, t2, t3, etc., associated with the search session.

Search system 225 may also, or alternatively, compare one or more of the component sequences to one or more component sequences that correspond to triggering sequences to determine a first degree of match. For example, as shown in FIG. 7A, graph 700 may include a set of triggering horizontal sequences 705, a horizontal sequence 710, and a set of non-triggering horizontal sequences 715 as a function of horizontal position, e.g., as shown as a vertical axis labeled as “horizontal position,” within search results documents and as a function of time, e.g., as shown by a horizontal axis labeled “time.”

Triggering horizontal sequences 705 may be associated with a set of triggering sequences. Each triggering horizontal sequence 705 may, for example, represent horizontal positions of a cursor, within a search results document obtained during a previous search session, that resulted in detecting a long hover event. Horizontal sequence 710 may represent a horizontal sequence obtained from the cursor sequence, for a current session, generated by search system 225 based on the cursor information. Horizontal sequence 710 may, for example, be based on the horizontal values, e.g., x1, x2, x3, etc., as a function of time, e.g., t1, t2, t3, etc. Non-triggering horizontal sequences 715 may be associated with a set of non-triggering sequences. Each non-triggering horizontal sequence 715 may, for example, represent horizontal positions of a cursor, within a search results document obtained during a previous search session, that resulted in detecting a short hover event.

Search system 225 may determine a how closely horizontal sequence 710 matches each triggering horizontal sequence 705. In some examples, search system 225 may determine a quantity of horizontal values, of horizontal sequence 710, that match horizontal values of each of triggering horizontal sequences 705. Search system 225 may determine that horizontal sequence 710 most closely matches a particular triggering horizontal sequence 705 with which a greatest quantity of matching horizontal values is associated. Search system 225 may determine the first degree of match based on the greatest quantity of matching horizontal values between horizontal sequence 710 and the particular triggering horizontal sequence 705.

Additionally, or alternatively, search system 225 may determine how closely horizontal sequence 705 matches each triggering horizontal sequence 710 based on distances, e.g., Euclidean distances, etc., between horizontal sequence 710 and each triggering horizontal sequence 705. For example, a first distance may be determined between horizontal sequence 710 and a first triggering horizontal sequence 705 based on a first difference between a first horizontal value of horizontal sequence 710 and a first horizontal value of first triggering horizontal sequence 705; a second difference between a second horizontal value of horizontal sequence 710 and a second horizontal value of first triggering horizontal sequence 705; and so on for each horizontal value. In some examples, the first distance, e.g., d1, may be determined based on:

d1≅((x1₇₁₀−x1₇₀₅)²+ . . . +(xQ₇₁₀−xQ₇₀₅)²)^{1/2}

where Q>1, where x1₇₁₀, . . . xQ₇₁₀ represent horizontal values associated with horizontal sequence 710, and where x1₇₀₅, . . . xQ₇₀₅ represent horizontal values associated with first triggering horizontal sequence 705.

Similarly, search system 225 may determine distances between horizontal sequence 710 and each triggering horizontal sequence 705 and may determine that horizontal sequence 710 most closely matches a particular triggering horizontal sequence 705 with which a shortest distance is associated. Thus, search system 225 may determine the first degree of match based on the shortest distance between horizontal sequence 710 and the particular triggering horizontal sequence 705.

Additionally, or alternatively, search system 225 may determined a combined distance, e.g., based on an average of the distances, etc., and may determine that the first degree of match corresponds to the combined distance.

As shown in FIG. 7B, graph 725 may include a set of triggering vertical sequences 730, a vertical sequence 735, and a set of non-triggering vertical sequences 740 as a function of vertical positions within one or more search results documents, e.g., as shown as a vertical axis labeled as “vertical position,” and as a function of time, e.g., as shown by a horizontal time axis labeled “time”.

Triggering vertical sequences 730 may be associated with a set of triggering sequences. Each triggering vertical sequence 730 may, for example, represent vertical positions of a cursor, within a search results document obtained during a respective previous search session, that resulted in detecting a long hover event. Vertical sequence 735 may represent a vertical sequence obtained from the cursor sequence, associated with the current session, generated by search system 225 based on the cursor information. Non-triggering vertical sequences 740 may be associated with a set of non-triggering sequences. Each non-triggering vertical sequence 740 may, for example, represent vertical positions of a cursor, within a search results document obtained during a previous search session, that resulted in detecting a short hover event.

Search system 225 may, in a manner similar to that described above, determine how closely vertical sequence 735 matches each of triggering vertical sequences 730. Search system 225 may determine that vertical sequence 735 most closely matches a particular triggering vertical sequence 730 with which a greatest quantity of matching vertical values is associated. Search system 225 may determine the first degree of match based on the greatest quantity of matching vertical values between vertical sequence 735 and the particular triggering vertical sequence 730.

Additionally, or alternatively, search system 225 may, in a manner similar to that described above, determine how closely vertical sequence 735 matches each triggering vertical sequence 730 based on distances between vertical sequence 735 and each triggering vertical sequence 730. Search system 225 may determine a first degree of match based on a shortest distance between vertical sequence 735 and a particular triggering vertical sequence 730. Additionally, or alternatively, search system 225 may determine a combined distance between vertical sequence 735 and each of triggering vertical sequences 730 and may determine that the first degree of match corresponds to the combined distance.

As shown in FIG. 7C, graph 750 may include a set of triggering velocity sequences 755, a velocity sequence 760, and a set of non-triggering velocity sequences 765 as a function of cursor velocity within one or more search results documents, e.g., as shown as a vertical axis labeled as “cursor velocity,” and as a function of time, e.g., as shown by a horizontal time axis labeled “time.”

Triggering velocity sequences 755 may be associated with a set of triggering sequences. Each triggering velocity sequence 755 may, for example, represent cursor velocity, within a search results document obtained during a respective previous search session, that resulted in detecting a long hover event. Velocity sequence 760 may represent a velocity sequence obtained from the cursor sequence, associated with the current session, generated by search system 225 based on the cursor information. Non-triggering velocity sequences 765 may be associated with a set of non-triggering sequences. Each non-triggering velocity sequence 765 may, for example, represent cursor velocity, within a search results document obtained during a respective previous search session, that resulted in detecting a short hover event.

Search system 225 may, in a manner similar to that described above, determine how closely velocity sequence 760 matches each triggering velocity sequence 755. Search system 225 may, for example, determine that vertical sequence 735 most closely matches a particular triggering velocity sequence 755 with which a greatest quantity of matching velocity values is associated. Search system 225 may determine the first degree of match based on the greatest quantity of matching velocity values between velocity sequence 760 and the particular triggering velocity sequence 755.

Additionally, or alternatively, search system 225 may, in a manner similar to that described above, determine how closely velocity sequence 760 matches each triggering velocity sequence 755 based on distances between velocity sequence 760 and each triggering velocity sequence 755. Search system 225 may determine the first degree of match based on a shortest distance between velocity sequence 760 and a particular triggering velocity sequence 755. Additionally, or alternatively, search system 225 may determined a combined distance between velocity sequence 760 and each of triggering velocity sequences 755 and may determine that the first degree of match corresponds to the combined distance.

As shown in FIG. 7D, graph 775 may include a set of triggering acceleration sequences 780, an acceleration sequence 785, and a set of non-triggering acceleration sequences 790 as a function of cursor acceleration within one or more search results documents, e.g., as shown as a vertical axis labeled as “cursor acceleration,” and as a function of time, e.g., as shown by a horizontal time axis labeled “time.”

Triggering acceleration sequences 780 may be associated with a set of triggering sequences. Each triggering acceleration sequence 780 may, for example, represent cursor acceleration, within a search results document obtained during a respective previous search session, that resulted in detecting a long hover event. Acceleration sequence 785 may represent an acceleration sequence obtained from the cursor sequence, associated with a current session, generated by search system 225 based on the cursor information. Non-triggering acceleration sequences 790 may be associated with a set of non-triggering sequences. Each non-triggering acceleration sequence 790 may, for example, represent cursor acceleration, within a search results document obtained during a respective previous search session, that resulted in detecting a short hover event.

Search system 225 may, in a manner similar to that described above, determine how closely acceleration sequence 785 matches each triggering acceleration sequence 780. Search system 225 may, for example, determine that acceleration sequence 785 most closely matches a particular triggering acceleration sequence 780 with which a greatest quantity of matching acceleration values is associated. Search system 225 may determine the first degree of match based on the greatest quantity of matching acceleration values between acceleration sequence 780 and the particular triggering acceleration sequence 785.

Additionally, or alternatively, search system 225 may, in a manner similar to that described above, determine how closely acceleration sequence 785 matches each triggering acceleration sequence 780 based on distances between acceleration sequence 785 and each triggering acceleration sequence 780. Search system 225 may determine a first degree of match based on a shortest distance between acceleration sequence 785 and a particular triggering acceleration sequence 780. Additionally, or alternatively, search system 225 may determine a combined distance between acceleration sequence 785 and each of triggering acceleration sequences 780 and may determine that the first degree of match corresponds to the combined distance.

Returning to FIG. 6, search system 225 may, thus, determine how closely the cursor sequence matches one or more triggering sequences based on the first degree of match between the horizontal sequence and triggering horizontal sequences; the first degree of match between the vertical sequence and triggering vertical sequences; the first degree of match between the velocity sequence and triggering velocity sequences; the first degree of match between the acceleration sequence and the triggering acceleration sequences; and/or any combination thereof. In some example implementations, the first degree of match, for the cursor sequence, may reflect a weighted combination of the first degrees of match of the component sequences, where one or more of the first degrees of match, associated with the component sequences, may be weighted differently.

For example, the first degree of match may correspond to a quantity of matching values, e.g., Q, that are based on the quantity of matching horizontal values, e.g., QX; the quantity of matching vertical values, e.g., QY; the quantity of matching velocity values, e.g., QV; the quantity of matching acceleration values, e.g., QA; or some combination thereof, e.g., Q=QX+QY+QV+QA, etc. Additionally, or alternatively, the first degree of match may be based on a weighted combination of the matching values, e.g., Q=W1*QX+W2*QY+W3*QV+W4*QA where W1 through W4 represent weighting values 0≦W≦1, and/or where W1+W2+W3+W4=1. Thus, the first degree of match may be based on a combination of differently weighted matching values. By way of example, the first degree of match may be based on a combination of a fifteen percent portion of the quantity of matching horizontal values; a fifteen percent portion of matching vertical values; a forty percent portion of matching velocity values; and/or thirty percent portion of the quantity of matching acceleration values, e.g., Q=0.15*QX+0.15*QY+0.4*QV+0.3*QA. The weighting values may be predetermined by search system 225 and/or may be set by an operator of server 220.

The first degree of match may also, or alternatively, correspond to a distance that is based on a combination of the shortest distance between the horizontal sequence and one of the triggering horizontal sequences; the shortest distance between the vertical sequence and one of the triggering vertical sequences; the shortest distance between the velocity sequence and one of the triggering velocity sequences; the shortest distance between the acceleration sequence and one of the triggering acceleration sequences; or some combination thereof. Additionally, or alternatively, the first degree of match may also, or alternatively, correspond to a distance that is based on the combination of distances, e.g., an average distance, etc., between the horizontal sequence and the triggering horizontal sequences; the combination of distances between the vertical sequence and the triggering vertical sequences; the combination of distances between the velocity sequence and the triggering velocity sequences; the combination of distances between the acceleration sequence and the triggering acceleration sequences; or some combination thereof. Search system 225 may also, or alternatively, determine the first degree of match based on a weighted combination of the shortest distances and/or the combined distances in a manner similar to that described above.

As further shown in FIG. 6, process 600 may include determining a second degree of match between the cursor sequence and a non-triggering sequence (block 630). For example, search system 225 may compare one or more of the component sequences associated with the cursor sequence, e.g., the horizontal sequence, the vertical sequence, the velocity sequence, the acceleration sequence, etc., to one or more component sequences that correspond to non-triggering sequences to determine a second degree of match.

Search system 225 may, for example and in a manner similar to that described above with respect to block 625, determine how closely horizontal sequence 710, of FIG. 7A, matches each of non-triggering horizontal sequences 715 of FIG. 7A. In some examples, search system 225 may determine a quantity of horizontal values, of horizontal sequence 710, that match horizontal values of each of non-triggering horizontal sequences 715. Search system 225 may determine that horizontal sequence 710 most closely matches a particular non-triggering horizontal sequence 715 with which a greatest quantity of matching horizontal values are associated. Search system 225 may determine the second degree of match based on the greatest quantity of matching horizontal values between horizontal sequence 710 and the particular non-triggering horizontal sequence 715.

Additionally, or alternatively, search system 225 may, in a manner similar to that described above with respect to block 625, determine how closely horizontal sequence 710 matches each non-triggering horizontal sequence 715 based on distances (e.g., Euclidean distances, etc.). For example, search system 225 may determine distances between horizontal sequence 710 and each of non-triggering sequences 715. Search system 225 may determine that horizontal sequence 710 most closely matches a particular non-triggering horizontal sequence 715 with which a shortest distance is associated. Search system 225 may, thus, determine that the second degree of match corresponds to the shortest distance between horizontal sequence 710 and the particular non-triggering horizontal sequence 715. Additionally, or alternatively, search system 225 may determined a combined distance between horizontal sequence 710 and each of non-triggering horizontal sequences 715 and may determine that the second degree of match corresponds to the combined distance.

Search system 225 may also, or alternatively and in a manner similar to that described above with respect to block 625, determine how closely vertical sequence 735, FIG. 7B, matches each of non-triggering vertical sequences 740 of FIG. 7B. Search system 225 may, for example, determine that vertical sequence 735 most closely matches a particular non-triggering vertical sequence 740 with which a greatest quantity of matching vertical values is associated. Search system 225 may also, or alternatively, determine the second degree of match based on the greatest quantity of matching vertical values between vertical sequence 735 and the particular non-triggering vertical sequence 735.

Additionally, or alternatively, search system 225 may, in a manner similar to that described above with respect to block 625, determine how closely vertical sequence 735 matches each of non-triggering vertical sequences 740 based on distances between vertical sequence 735 and each non-triggering vertical sequence 740. Search system 225 may also, or alternatively, determine the second degree of match based on a shortest distance between vertical sequence 735 and a particular non-triggering sequence 740. Search system 225 may also, or alternatively, determine a combined distance between vertical sequence 735 and each of non-triggering vertical sequences 740 and may determine the second degree of match based on the combined distance.

Search system 225 may also, or alternatively and in a manner similar to that described above with respect to block 625, determine how closely velocity sequence 760, of FIG. 7C, matches each of non-triggering velocity sequences 765 of FIG. 7C. Search system 225 may determine that velocity sequence 760 most closely matches a particular non-triggering velocity sequence 765 with which a greatest quantity of matching velocity values is associated. Search system 225 may determine the second degree of match based on the greatest quantity of matching velocity values between velocity sequence 760 and the particular non-triggering velocity sequence 765.

Additionally, or alternatively, search system 225 may, in a manner similar to that described above with respect to block 625, determine how closely velocity sequence 760 matches each non-triggering velocity sequence 765 based on distances between velocity sequence 760 and each non-triggering velocity sequence 765. Search system 225 may determine the second degree of match based on a shortest distance between velocity sequence 760 and a particular non-triggering velocity sequence 765. Additionally, or alternatively, search system 225 may determined a combined distance between velocity sequence 760 and each of non-triggering velocity sequences 765 and may determine that the second degree of match corresponds to the combined distance.

Search system 225 may also, or alternatively and in a manner similar to that described above with respect to block 625, determine how closely acceleration sequence 785, of FIG. 7D, matches each non-triggering acceleration sequence 790 of FIG. 7D. Search system 225 may, for example, determine that acceleration sequence 785 most closely matches a particular non-triggering acceleration sequence 790 with which a greatest quantity of matching acceleration values is associated. Search system 225 may determine the second degree of match based on the greatest quantity of matching acceleration values between acceleration sequence 785 and the particular non-triggering acceleration sequence 790.

Additionally, or alternatively, search system 225 may, in a manner similar to that described above with respect to block 625, determine how closely acceleration sequence 785 matches each non-triggering acceleration sequence 790 based on distances between acceleration sequence 785 and each non-triggering acceleration sequences 790. Search system 225 may determine the second degree of match based on a shortest distance between acceleration sequence 785 and a particular non-triggering acceleration sequence 790. Additionally, or alternatively, search system 225 may determine a combined distance between acceleration sequence 785 and each of non-triggering acceleration sequences 790 and may determine that the second degree of match corresponds to the combined distance.

Returning to FIG. 6, search system 225 may, thus, determine how closely the cursor sequence matches one or more non-triggering sequences, in a manner similar to that described above with respect to block 625, based on the second degree of match between the horizontal sequence and non-triggering horizontal sequences; the second degree of match between the vertical sequence and the non-triggering vertical sequences; the second degree of match between the velocity sequence and the non-triggering velocity sequences; the second degree of match between the acceleration sequence and the non-triggering acceleration sequences; and/or some combination thereof. The second degree of match, for the cursor sequence, may also, or alternatively, reflect a weighted combination of the second degrees of match of the component sequences, where one or more of the second degrees of match, associated with the component sequences, may be weighted differently in a manner similar to that described above with respect to block 625.

As still further shown in FIG. 6, if the first degree of match is less than the second degree of match by a first amount (block 635—YES), process 600 may include obtaining cursor information based on cursor movements within the search results document (block 615). For example, search system 225 may compare the first degree of match to the second degree of match to determine whether the first degree of match is less than the second degree of match by a first amount. The first amount may, for example, correspond to a predetermined constant, a percentage of the first degree of match, a percentage of the second degree of match, etc.

For example, search system 225 may compare a first greatest quantity of matching values, between the cursor sequence and the triggering sequences, with a second greatest quantity of matching values between the cursor sequence and the non-triggering sequences. When the first greatest quantity of matching values is less than the second greatest quantity of matching values, by the first amount, search system 225 may not detect a hover event.

Additionally, or alternatively, search system 225 may compare a first combined quantity of matching values between the cursor sequence and the triggering sequences, with a second combined quantity of matching values between the cursor sequence and the non-triggering sequences. When the first combined quantity of matching values is less than the second combined quantity of matching values, by the first amount, search system 225 may not detect the hover event.

Additionally, or alternatively, search system 225 may compare a first shortest distance, between the cursor sequence and the triggering sequences, to a second shortest distance, between the cursor sequence and the non-triggering sequences, to determine whether the first shortest distance is less than the second shortest distance. When the first shortest distance is not less than the second shortest distance, by the first amount, search system 225 may not detect the hover event.

Additionally, or alternatively, search system 225 may compare a first combined distance, between the cursor sequence and the triggering sequences, to a second combined distance, between the cursor sequence and the non-triggering sequences, to determine whether the first combined distance is less than the second combined distance. When the first combined distance is not less than the second combined distance, by the first amount, search system 225 may not detect the hover event.

When the hover event is not detected, search system 225 may not perform one or more acts, such as providing an information window for display on client 210. Search system 225 may also, or alternatively, continue to obtain cursor information, from client 210, when the hover event is not detected.

As yet further shown in FIG. 6, if the first degree of match is not less than the second degree of match by the first amount (block 635—NO) and if the first degree of match is greater than the second degree of match by a second amount (block 640—YES), process 600 may include performing one or more acts associated with detecting a hover event (block 645). For example, search system 225 may determine that the first greatest quantity of matching values is not less than the second greatest quantity of matching values by the first amount. When the first greatest quantity of matching values is not less than the second greatest quantity of matching values by the first amount, search system 225 may determine whether the first greatest quantity of matching values is greater than the second greatest quantity of matching values by a second amount. When the first greatest quantity of matching values is greater than the second greatest quantity of matching values by the second amount, search system 225 may detect a hover event. When the hover event is detected, search system 225 may perform one or more acts, such as, for example, providing an information window, to client 210, for display. The information window may correspond to an image over which the cursor is located when the hover event is detected.

Additionally, or alternatively, search system 225 may determine that the first combined quantity of matching values is not less than the second combined quantity of matching values by the first amount. When the first combined quantity of matching values is not less than the second combined quantity of matching values by the first amount, search system 225 may determine whether the first combined quantity of matching values is greater than the second combined quantity of matching values by the second amount. When the first combined quantity of matching values is greater than the second combined quantity of matching values by the second amount, search system 225 may detect the hover event and may perform the one or more acts as described above.

Additionally, or alternatively, search system 225 may determine that the first shortest distance is not less than the second shortest distance by the first amount. When the first shortest distance is not less than the second shortest distance by the first amount, search system 220 may determine whether the first shortest distance is less than the second shortest distance by the second amount. When the first shortest distance is less than the second shortest distance by the second amount, search system 225 may detect the hover event and may perform the one or more acts as described above.

Additionally, or alternatively, search system 225 may determine that the first combined distance is not less than the second combined distance by the first amount. When the first combined distance is not less than the second combined distance by the first amount, search system 220 may determine whether the first combined distance is less than the second combined distance by the second amount. When the first combined distance is less than the second combined distance by the second amount, search system 225 may detect the hover event and may perform the one or more acts as described above.

As also shown in FIG. 6, if the first degree of match is not greater than the second degree of match by the second amount (block 640—NO), process 600 may include determining whether a hover event is detected using a conventional scheme (block 650). For example, search system 225 may determine that the first greatest quantity of matching values is not greater than the second greatest quantity of matching values by the second amount; that the first combined quantity of matching values is not greater than the second combined quantity of matching values by the second amount; that the first shortest distance is not less than the second shortest distance by the second amount; and/or that the first combined distance is not less than the second combined distance by the second amount. Based on this determination, search system 225 may determine whether a hover event is detected using one or more known techniques. One such technique may cause search system 225 to perform the one or more acts, when the cursor hovers over a particular image, within the search results document, for a time period that is greater than a threshold. The threshold may be predetermined by server 220 and/or an operator of server 220. When the cursor hovers over the image for a time period that is not greater than the threshold, search system 225 may not detect the hover event and/or may continue to obtain cursor information associated with movements of the cursor within the search results document.

While process 600 has been described as being performed by search system 225 of server 220, some or all of process 600 may be performed by search system 225 of client 210.

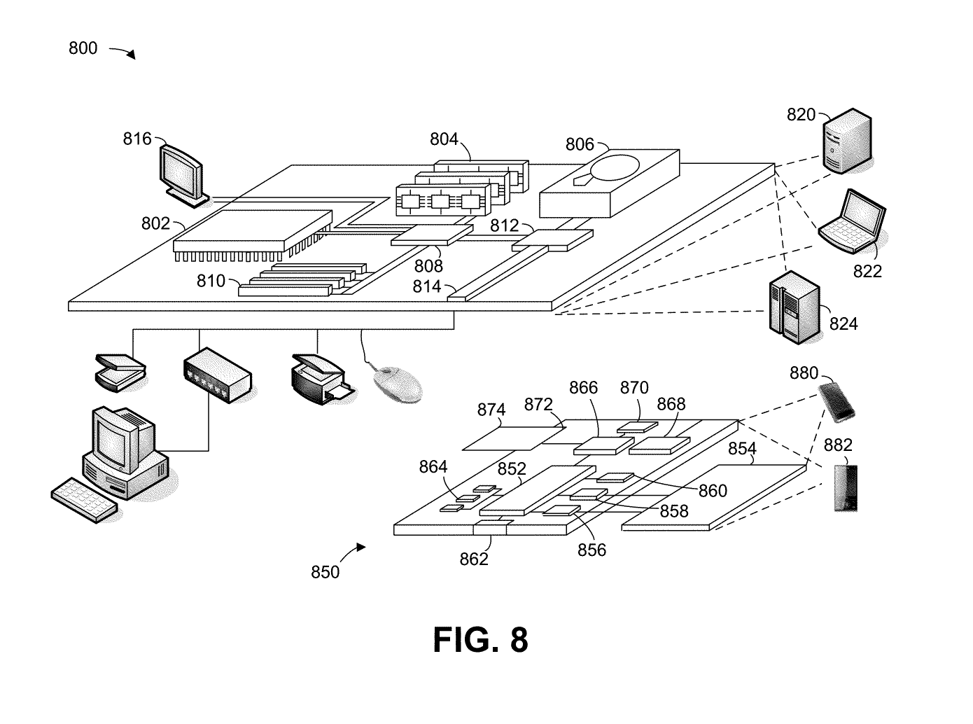

FIG. 8 is a diagram of an example of a generic computing device 800 and a generic mobile computing device 850, which may be used with the techniques described here. Generic computing device 800 or generic mobile computing device 850 may correspond to, for example, a user device 205, a client 210 and/or a server 220, 230, or 240. Computing device 800 is intended to represent various forms of digital computers, such as laptops, desktops, workstations, personal digital assistants, servers, blade servers, mainframes, and other appropriate computers. Mobile computing device 850 is intended to represent various forms of mobile devices, such as personal digital assistants, cellular telephones, smart phones, and other similar computing devices. The components shown in FIG. 8, their connections and relationships, and their functions, are meant to be examples only, and are not meant to limit implementations described herein.

Computing device 800 may include a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. Processor 802 can process instructions for execution within the computing device 800, including instructions stored in the memory 804 or on the storage device 806 to display graphical information for a graphical user interface, GUI, on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations, as a server bank, a group of blade servers, or a multi-processor system, etc.

Memory 804 stores information within the computing device 800. In some implementations, memory 804 includes a volatile memory unit or units. In another implementation, memory 804 includes a non-volatile memory unit or units. The memory 804 may also be another form of computer-readable medium, such as a magnetic or optical disk. A computer-readable medium may refer to a non-transitory memory device. A memory device may refer to storage space within a single storage device or spread across multiple storage devices.

The storage device 806 is capable of providing mass storage for the computing device 800. In some implementations, storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 804, storage device 806, or memory on processor 802.

High speed controller 808 manages bandwidth-intensive operations for the computing device 800, while low speed controller 812 manages lower bandwidth-intensive operations. Such allocation of functions is provided for explanatory purposes only. In some implementations, high-speed controller 808 is coupled to memory 804, display 816, e.g., through a graphics processor or accelerator, and to high-speed expansion ports 810, which may accept various expansion cards, not shown. In these implementations, low-speed controller 812 is coupled to storage device 806 and low-speed expansion port 814. The low-speed expansion port, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

Computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device, not shown, such as mobile computing device 850. Each of such devices may contain one or more of computing devices 800, 850, and an entire system may be made up of multiple computing devices 800, 850 communicating with each other.

Mobile computing device 850 may include a processor 852, a memory 864, an input/output, “I/O,” device, such as a display 854, a communication interface 866, and a transceiver 868, among other components. Mobile computing device 850 may also be provided with a storage device, such as a micro-drive or other device, to provide additional storage. Each of the components 850, 852, 864, 854, 866, and 868 are interconnected using various buses, and several of the components may be mounted on a common motherboard or in other manners as appropriate.

Processor 852 can execute instructions within mobile computing device 850, including instructions stored in memory 864. Processor 852 may be implemented as a chipset of chips that include separate and multiple analog and digital processors. Processor 852 may provide, for example, for coordination of the other components of mobile computing device 850, such as control of user interfaces, applications run by mobile computing device 850, and wireless communication by mobile computing device 850.

Processor 852 may communicate with a user through control interface 858 and display interface 856 coupled to a display 854. Display 854 may be, for example, a TFT LCD, Thin-Film-Transistor Liquid Crystal Display; or an OLED, Organic Light Emitting Diode, display; or other appropriate display technology. Display interface 856 may comprise appropriate circuitry for driving display 854 to present graphical and other information to a user. Control interface 858 may receive commands from a user and convert them for submission to the processor 852. In addition, an external interface 862 may be provide in communication with processor 852, so as to enable near area communication of mobile computing device 850 with other devices. External interface 862 may provide, for example, for wired communication in some implementations, or for wireless communication in other implementations, and multiple interfaces may also be used.

Memory 864 stores information within mobile computing device 850. Memory 864 can be implemented as one or more of a computer-readable medium or media, a volatile memory unit or units, or a non-volatile memory unit or units. Expansion memory 874 may also be provided and connected to mobile computing device 850 through expansion interface 872, which may include, for example, a SIMM, Single In Line Memory Module, card interface. Such expansion memory 874 may provide extra storage space for device 850, or may also store applications or other information for mobile computing device 850. Specifically, expansion memory 874 may include instructions to carry out or supplement the processes described above, and may include secure information also. Thus, for example, expansion memory 874 may be provide as a security module for mobile computing device 850, and may be programmed with instructions that permit secure use of device 850. In addition, secure applications may be provided via the SIMM cards, along with additional information, such as placing identifying information on the SIMM card in a non-hackable manner.

Expansion memory 874 may include, for example, flash memory and/or NVRAM memory. In some implementations, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Mobile computing device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver, not shown. In addition, GPS, Global Positioning System, receiver module 870 may provide additional navigation- and location-related wireless data to mobile computing device 850, which may be used as appropriate by applications running on mobile computing device 850.

Mobile computing device 850 may also communicate audibly using audio codec 860, which may receive spoken information from a user and convert it to usable digital information. Audio codec 860 may likewise generate audible sound for a user, such as through a speaker, e.g., in a handset of mobile computing device 850. Such sound may include sound from voice telephone calls, may include recorded sound, e.g., voice messages, music files, etc., and may also include sound generated by applications operating on mobile computing device 850.

Mobile computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described herein can be realized in digital electronic circuitry; integrated circuitry; specially designed ASICs, application specific integrated circuits; computer hardware; firmware; software; and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs—also known as programs, software, software applications or code—include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, e.g., magnetic discs, optical disks, memory, Programmable Logic Devices, “PLDs,” used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device, e.g., a CRT, cathode ray tube, or LCD, liquid crystal display, monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The technologies and/or techniques described herein can be implemented in a computing system that includes a back end component, e.g., as a data server, or that includes a middleware component, e.g., an application server, or that includes a front end component, e.g., a client computer having a graphical user interface or a Browser through which a user can interact with an implementation of the systems and techniques described here, or any combination of such back end, middleware, or front end components. The components of the system can be interconnected by any form or medium of digital data communication, e.g., a communication network. Examples of communication networks include a LAN, a WAN, and the Internet.

Technologies and/or techniques, described herein, may enable a search system to monitor cursor movements within a search results document that includes a set of images that are relevant to a search query received from a client. The search system may generate a cursor sequence based on information associated with the cursor movements. The search system may determine a first degree of match between the cursor sequence and a triggering sequence and a second degree of match between the cursor sequence and a non-triggering sequence. The search system may detect a hover event when the first degree of match is greater than the second degree of match and may cause an information window to appear within the search results document. The search system may not detect a hover event when the first degree of match is not greater than the second degree of match and may continue to monitor the cursor movements within the search results document. In this way, the search system may reduce a quantity of times that a hover event is detected when a user, of the client, did not intend the hover event to be detected, which may improve the user experience.

The foregoing description provides illustration and description, but is not intended to be exhaustive or to limit the implementations to the precise form disclosed. Modifications and variations are possible in light of the above implementations or may be acquired from practice of the implementations.

For example, while series of blocks have been described with regard to FIGS. 3, 5 and 6, the order of the blocks may be modified in other implementations. Further, non-dependent blocks may be performed in parallel.

Also, some implementations have been described as detecting hover events in relation to a search results document that contains a listing of image results. In some implementations, similar techniques may be used to detect hover events in relation to search results documents that include listings of search results that contain search results other than image results. In some implementations, similar techniques may be used to detect hover events in relation to documents other than search results documents.

As used herein, the term component is intended to be broadly interpreted to refer to hardware or a combination of hardware and software, such as software executed by hardware, such as a processor.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method comprising:
storing, by one or more computer devices, information regarding a first cursor sequence that resulted in an occurrence of a hover event, and information regarding a second cursor sequence that did not result in an occurrence of the hover event,
the first cursor sequence and the second cursor sequence identifying a manner in which a particular cursor was moved relative to a display of a particular document;
obtaining, by the one or more computer devices, cursor information that identifies a manner in which a cursor is moved relative to a display of a document;
comparing, by the one or more computer devices, the cursor information to the first cursor sequence and the second cursor sequence;
determining, by the one or more computer devices and based on a result of comparing the cursor information to the first cursor sequence and the second cursor sequence, that the hover event occurred when the cursor information more closely matches the first cursor sequence than the second cursor sequence; and
performing, by the one or more computer devices, an action based on determining that the hover event occurred.

2. The method of claim 1, further comprising:
determining that the hover event did not occur when the cursor information more closely matches the second cursor sequence than the first cursor sequence; and
precluding the action from being performed based on determining that the hover event did not occur.

3. The method of claim 1, where obtaining the cursor information includes at least one of:
obtaining information that identifies a location of the cursor, relative to the display of the document, as the cursor is moved with respect to the display of the document;
obtaining information that identifies a velocity of the cursor, as the cursor is moved with respect to the display of the document; or
obtaining information that identifies an acceleration of the cursor, as the cursor is moved with respect to the display of the document.

4. The method of claim 1, further comprising:
generating a sequence based on the cursor information, the sequence including at least one of:
one or more first values that correspond to a horizontal location of the cursor, as a function of time, when the cursor is moved with respect to the display of the document,
one or more second values that correspond to a vertical location of the cursor, as a function of time, when the cursor is moved with respect to the display of the document,
one or more third values that correspond to a velocity of the cursor, as a function of time, when the cursor is moved with respect to the display of the document, or
one or more fourth values that correspond to an acceleration of the cursor, when the cursor is moved with respect to the display of the document.

5. The method of claim 4, where comparing the cursor information to the first cursor sequence and the second cursor sequence includes:
comparing the sequence to the first cursor sequence and the second cursor sequence to determine whether the sequence more closely matches the first cursor sequence or the second cursor sequence.

6. The method of claim 5, where comparing the sequence to the first cursor sequence and the second cursor sequence includes:
calculating a first difference between the sequence and the first cursor sequence,
calculating a second difference between the sequence and the second cursor sequence, and
comparing the first difference and the second difference to determine whether the hover event occurred,
the hover event occurring when the first difference is smaller than the second difference.

7. The method of claim 1, further comprising:
identifying a time period during which the cursor remains located over an area, within the display of the document, after the hover event occurred; and
using the cursor information to update the information regarding the first cursor sequence when the time period satisfies a first threshold,
using the cursor information to update the information regarding the second cursor sequence when the time period satisfies a second threshold, the second threshold being less than the first threshold, or
using the cursor information to update neither the information regarding the first cursor sequence nor the information regarding the second cursor sequence when the time period is does not satisfy the first threshold or the second threshold.

8. A computer-readable medium, comprising:
a plurality of instructions which, when executed by one or more processors, causes the one or more processors to:
store information regarding a first cursor sequence that resulted in an occurrence of a hover event, and information regarding a second cursor sequence that did not result in an occurrence of the hover event,
the first cursor sequence and the second cursor sequence identifying a manner in which a particular cursor was moved relative to a display of a particular document;
obtain cursor information that identifies a manner in which a cursor is moved relative to a display of a document;
compare the cursor information to the first cursor sequence and the second cursor sequence;
determine, based on a result of comparing the cursor information to the first cursor sequence and the second cursor sequence, that the hover event occurred when the cursor information more closely matches the first cursor sequence than the second cursor sequence; and
perform an action based on determining that the hover event occurred.

9. The computer-readable medium of claim 8, where the plurality of instructions further causes the one or more processors to:
determine that the hover event did not occur when the cursor information more closely matches the second cursor sequence than the first cursor sequence; and
preclude the action from being performed based on determining that the hover event did not Occur.

10. The computer-readable medium of claim 8, where one or more instructions, of the plurality of instructions, to obtain the cursor information include one or more instructions which cause the one or more processors to at least one of:
obtain information that identifies a location of the cursor, relative to the display of the document, as the cursor is moved with respect to the display of the document;
obtain information that identifies a velocity of the cursor, as the cursor is moved with respect to the display of the document; or
obtain information that identifies an acceleration of the cursor, as the cursor is moved with respect to the display of the document.

11. The computer-readable medium of claim 8, where the plurality of instructions further causes the one or more processors to:
generate a sequence based on the cursor information, the sequence including at least one of:
one or more first values that correspond to a horizontal location of the cursor, as a function of time, when the cursor is moved with respect to the display of the document,
one or more second values that correspond to a vertical location of the cursor, as a function of time, when the cursor is moved with respect to the display of the document,
one or more third values that correspond to a velocity of the cursor, as a function of time, when the cursor is moved with respect to the display of the document, or
one or more fourth values that correspond to an acceleration of the cursor, when the cursor is moved with respect to the display of the document.

12. The computer-readable medium of claim 11, where one or more instructions, of the plurality of instructions, to compare the cursor information to the first cursor sequence and the second cursor sequence include one or more instructions which cause the one or more processors to:
compare the sequence to the first cursor sequence and the second cursor sequence to determine whether the sequence more closely matches the first cursor sequence or the second cursor sequence.

13. The computer-readable medium of claim 12, where one or more instructions, of the plurality of instructions, to compare the sequence to the first cursor sequence and the second cursor sequence include one or more instructions which cause the one or more processors to:
calculate a first difference between the sequence and the first cursor sequence,
calculate a second difference between the sequence and the second cursor sequence, and
compare the first difference and the second difference to determine whether the hover event occurred,
the hover event occurring when the first difference is smaller than the second difference.

14. The computer-readable medium of claim 8, where the plurality of instructions further causes the one or more processors to:
identify a time period during which the cursor remains located over an area, within the display of the document, after the hover event occurred; and
use the cursor information to update the information regarding the first cursor sequence when the time period satisfies a first threshold,
use the cursor information to update the information regarding the second cursor sequence when the time period satisfies a second threshold, the second threshold being less than the first threshold, or
use the cursor information to update neither the information regarding the first cursor sequence nor the information regarding the second cursor sequence when the time period is does not satisfy the first threshold or the second threshold.

15. A system, comprising:
one or more computer devices to:
store information regarding a first cursor sequence that resulted in an occurrence of a hover event, and information regarding a second cursor sequence that did not result in an occurrence of the hover event,
the first cursor sequence and the second cursor sequence identifying a manner in which a particular cursor was moved relative to a display of a particular document;
obtain cursor information that identifies a manner in which a cursor is moved relative to a display of a document;
compare the cursor information to the first cursor sequence and the second cursor sequence;
determine, based on a result of comparing the cursor information to the first cursor sequence and the second cursor sequence, that the hover event occurred when the cursor information more closely matches the first cursor sequence than the second cursor sequence; and
perform an action based on determining that the hover event occurred.

16. The system of claim 15, where the one or more computer devices are further to:
determine that the hover event did not occur when the cursor information more closely matches the second cursor sequence than the first cursor sequence; and
preclude the action from being performed based on determining that the hover event did not Occur.

17. The system of claim 15, where the one or more computer devices, when obtaining the cursor information, are to:
obtain information that identifies a location of the cursor, relative to the display of the document, as the cursor is moved with respect to the display of the document;
obtain information that identifies a velocity of the cursor, as the cursor is moved with respect to the display of the document; or
obtain information that identifies an acceleration of the cursor, as the cursor is moved with respect to the display of the document.

18. The system of claim 15, where the one or more computer devices are further to:
generate a sequence based on the cursor information, the sequence including at least one of:
one or more first values that correspond to a horizontal location of the cursor, as a function of time, when the cursor is moved with respect to the display of the document,
one or more second values that correspond to a vertical location of the cursor, as a function of time, when the cursor is moved with respect to the display of the document,
one or more third values that correspond to a velocity of the cursor, as a function of time, when the cursor is moved with respect to the display of the document, or
one or more fourth values that correspond to an acceleration of the cursor, when the cursor is moved with respect to the display of the document.

19. The system of claim 18, where the one or more computer devices, when comparing the cursor information to the first cursor sequence and the second cursor sequence, are to:
calculate a first difference between the sequence and the first cursor sequence,
calculate a second difference between the sequence and the second cursor sequence, and
compare the first difference and the second difference to determine whether the hover event occurred,
the hover event occurring when the first difference is smaller than the second difference.

20. The system of claim 15, where the one or more computer devices are further to:
identify a time period during which the cursor remains located over an area, within the display of the document, after the hover event occurred; and
use the cursor information to update the information regarding the first cursor sequence when the time period satisfies a first threshold,
use the cursor information to update the information regarding the second cursor sequence when the time period satisfies a second threshold, the second threshold being less than the first threshold, or
use the cursor information to update neither the information regarding the first cursor sequence nor the information regarding the second cursor sequence when the time period is does not satisfy the first threshold or the second threshold.
